(19) United States
(12) Patent Application Publication
(10) Pub. No.: US 2026/0051638 A1
(43) Pub. Date: Feb. 19, 2026

(54) BATTERY MODULE ASSEMBLY

(71) Applicant: Rivian IP Holdings, LLC, Irvine, CA (US)

(72) Inventors: Tyler JACOBS, Hawthorne, CA (US); Jonathan Christopher WILSON, Rancho Mission Viejo, CA (US); Mukund GANAPATHY, Newark, CA (US); David Warren VANZANT, Norco, CA (US); Christopher Surya KOMPELLA, Saratoga, CA (US); Vinay Vilas JADHAV, Fremont, CA (US); Karteek PALLERLA, Irvine, CA (US); Lizzie WINK, Long Beach, CA (US); Najmeh RAHIMI, Huntington Beach, CA (US); Rafael LUJAN, Huntington Beach, CA (US); Akshay Kishor MURKUTE, Irvine, CA (US); Nicholas TEOH, Lake Forest, CA (US); Karthik Gundappa BALTE, Tustin, CA (US); Samuel Edward HUGLEY, Long Beach, CA (US)

(21) Appl. No.: 19/272,970

(22) Filed: Jul. 17, 2025

Related U.S. Application Data
(60) Provisional application No. 63/684,233, filed on Aug. 16, 2024.
(60) Provisional application No. 63/807,457, filed on May 16, 2025.

(51) Int. Cl. H01M 50/588; B60L 50/64; H01M 50/213; H01M 50/249; H01M 50/262; H01M 50/271; H01M 50/503; H01M 50/505

(52) U.S. Cl. CPC H01M 50/588; B60L 50/64; H01M 50/213; H01M 50/249; H01M 50/262; H01M 50/271; H01M 50/503; H01M 50/505; H01M 2220/20

(57) ABSTRACT

A battery module may include features to support and protect components thereof from external stress and from certain electrical conditions. In particular, a battery module can be provided with components that direct forces away from electrical connection regions, such as at terminals of a battery cell. Such forces can be directed toward other structures that do not define electrical connection regions. A battery module can also be provided with features, such as a series busbar that electrically connects sets of battery cells, that enhance protections from certain electrical conditions. An assembly for such a battery module can provide guidance to align and secure assembled components and to retain them with a potting material during assembly.

### CROSS-REFERENCE TO RELATED APPLICATIONS

This application claims the benefit of U.S. Provisional Application No. 63/684,233, entitled “BATTERY MODULE ASSEMBLY,” filed Aug. 16, 2024, and U.S. Provisional Application No. 63/807,457, entitled “BATTERY MODULE ASSEMBLY,” filed May 16, 2025, the entirety of each of which is incorporated herein by reference.

### INTRODUCTION

Batteries are often used as a source of power, including as a source of power for electric vehicles that include wheels that are driven by an electric motor that receives power from the batteries. A battery may include several battery cells carried within a module and/or a carrier.

Aspects of the subject technology can help to improve the durability and longevity of batteries of electric vehicles, which can help to mitigate climate change by reducing greenhouse gas emissions.

### SUMMARY

A battery module may include features to support and protect components thereof from external stress and from certain electrical conditions. In particular, a battery module can be provided with components that direct forces away from electrical connection regions, such as at terminals of a battery cell. Such forces can be directed toward other structures that do not define electrical connection regions. A battery module can also be provided with features, such as a series busbar that electrically connects sets of battery cells, that enhance protections from certain electrical conditions. An assembly for such a battery module can provide guidance to align and secure assembled components and to retain them with a potting material during assembly.

According to one or more implementations of the present disclosure, a battery subassembly is described. The battery subassembly may include a cover, a frame for abutting a peripheral rim of a battery cell, and a current collector assembly between the frame and the cover, wherein the cover is configured to direct forces applied thereto away from an encapsulant between the cover and a central portion of the battery cell and onto the peripheral rim of the battery cell.

The current collector assembly can include a first interconnect portion and a second interconnect portion. The encapsulant can be configured to contain a first region at which the first interconnect portion is connected to a first terminal of the battery cell and a second region at which the second interconnect portion is connected to a second terminal of the battery cell.

The frame can define an opening for exposing (i) the central portion of the battery cell for connection to the first interconnect portion and (ii) a portion of the peripheral rim for connection to the second interconnect portion. The cover can form an inner surface defining a concave shape for facing the encapsulant and the central portion of the battery cell. The encapsulant can have a modulus of elasticity that is lower than a modulus of elasticity of the cover and a modulus of elasticity of the frame. The battery subassembly can include a layer of foam on a side of the cover that is opposite the frame. The battery subassembly can include a base, a potting dam extending along an end of the frame to the base, and potting material between the cover and the base.

The battery cell can be one of a first set of battery cells. The battery subassembly can include a series busbar for electrically connecting the first set of battery cells to a second set of battery cells, wherein the series busbar occupies a plane occupied by the current collector assembly. The frame can be a first frame, the battery subassembly further comprising a second frame, wherein each of the first frame and the second frame is for covering a respective portion of the first set of battery cells and the second set of battery cells.

The first frame can include first engagers for forming a 4-way datum with the first set of battery cells and second engagers for forming a 2-way datum with the first set of battery cells. The first frame can include third engagers for forming a 4-way datum with the current collector assembly. The first frame can include fourth engagers for forming a 4-way datum with the cover.

According to one or more implementations of the present disclosure, a series busbar is described. The series busbar may include a first terminal, a second terminal, and multiple fuse elements connecting, in parallel, the first terminal and the second terminal, wherein each of the multiple fuse elements has a different cross-sectional dimension.

The fuse elements can include a first fuse element of the multiple fuse elements on a first side of the series busbar that is configured to connect to a current collector assembly has a first cross-sectional dimension, and a second fuse element of the multiple fuse elements on a second side, opposite the first side, of the series busbar that is configured to face away from the current collector assembly has a second cross-sectional dimension, greater than the first cross-sectional dimension. The first terminal, the second terminal, and the multiple fuse elements can form a monolithic structure. A non-conductive container can surround the multiple fuse elements.

According to one or more implementations of the present disclosure, a method of assembling a battery subassembly is described. The method may include providing a first set of battery cells and a second set of battery cells, wherein each of the battery cells of the first set of battery cells and the second set of battery cells defines a central portion including a first terminal and a peripheral rim including a second terminal, providing one or more frames abutting the peripheral rim of each of the battery cells, connecting a current collector assembly to the first terminal and the second terminal of each of the battery cells, providing an encapsulant over the central portion of each of the battery cells, and providing a cover over the current collector assembly and each encapsulant.

A series busbar can be connected to the first set of battery cells and the second set of battery cells, wherein the cover extends over the series busbar. A base can be provided to support the first set of battery cells and the second set of battery cells. One or more potting dams can be provided each extending along a respective end of the one or more frames to the base. Potting material can be provided between the cover and the base.

### BRIEF DESCRIPTION OF THE DRAWINGS

Certain features of the subject technology are set forth in the appended claims. However, for purpose of explanation, several embodiments of the subject technology are set forth in the following figures.

FIG. 1A and FIG. 1B illustrate schematic perspective side views of example implementations of a vehicle having a battery pack, in accordance with one or more implementations of the present disclosure.

FIG. 1C illustrates a schematic perspective view of a building having a battery pack, in accordance with one or more implementations of the present disclosure.

FIG. 2A illustrates a schematic perspective view of a battery pack, in accordance with one or more implementations of the present disclosure.

FIG. 2B illustrates schematic perspective views of various battery modules that may be included in a battery pack, in accordance with one or more implementations of the present disclosure.

FIG. 2C illustrates a cross-sectional end view of a battery cell, in accordance with one or more implementations of the present disclosure.

FIG. 2D illustrates a cross-sectional perspective view of a cylindrical battery cell, in accordance with one or more implementations.

FIG. 2E illustrates a cross-sectional perspective view of a prismatic battery cell, in accordance with one or more implementations of the present disclosure.

FIG. 2F illustrates a cross-sectional perspective view of a pouch battery cell, in accordance with one or more implementations of the present disclosure.

FIG. 3 illustrates a perspective view of an example battery cell in accordance with one or more implementations of the present disclosure.

FIG. 4 illustrates an exploded perspective view of a battery module in accordance with one or more implementations of the present disclosure.

FIG. 5 illustrates a sectional side view of a portion of a battery module in accordance with one or more implementations of the present disclosure.

FIG. 6 illustrates a top view of multiple frames on battery cells of a battery module in accordance with one or more implementations of the present disclosure.

FIG. 7 illustrates a bottom view of a first portion of a frame on battery cells of a battery module in accordance with one or more implementations of the present disclosure.

FIG. 8 illustrates a bottom view of a second portion of a frame on battery cells of a battery module in accordance with one or more implementations of the present disclosure.

FIG. 9 illustrates a top view of a current collector assembly on a frame and battery cells of a battery module in accordance with one or more implementations of the present disclosure.

FIG. 10 illustrates a top view of a portion of frame on a battery cell of a battery module in accordance with one or more implementations of the present disclosure.

FIG. 11 illustrates a top view of a portion of a current collector assembly on the frame and the battery cell of FIG. 10 in accordance with one or more implementations of the present disclosure.

FIG. 12 illustrates a top view of encapsulants on a frame and battery cells of a battery module in accordance with one or more implementations of the present disclosure.

FIG. 13A illustrates a perspective view of a cover in accordance with one or more implementations of the present disclosure.

FIG. 13B illustrates a perspective view of a cover in accordance with one or more implementations of the present disclosure.

FIG. 13C illustrates a perspective view of a cover in accordance with one or more implementations of the present disclosure.

FIG. 13D illustrates a top view of a cover in accordance with one or more implementations of the present disclosure.

FIG. 13E illustrates a perspective view of a portion of the cover of FIG. 13D in accordance with one or more implementations of the present disclosure.

FIG. 13F illustrates a perspective view of a cover in accordance with one or more implementations of the present disclosure.

FIG. 13G illustrates a bottom view of a cover in accordance with one or more implementations of the present disclosure.

FIG. 13H illustrates a perspective view of a cover in accordance with one or more implementations of the present disclosure.

FIG. 14A illustrates an exploded perspective view of a cover above a current collector assembly of a battery module in accordance with one or more implementations of the present disclosure.

FIG. 14B illustrates a top view of a cover on a frame of a battery module in accordance with one or more implementations of the present disclosure.

FIG. 15A illustrates a perspective view of a busbar of a battery module in accordance with one or more implementations of the present disclosure.

FIG. 15B illustrates a perspective view of the busbar of FIG. 15A with an enclosure in accordance with one or more implementations of the present disclosure.

FIG. 16A illustrates a perspective view of a portion of a busbar of a battery module in accordance with one or more implementations of the present disclosure.

FIG. 16B illustrates a perspective view of a first portion of a container for a busbar in accordance with one or more implementations of the present disclosure.

FIG. 16C illustrates a perspective view of a second portion of a container for a busbar in accordance with one or more implementations of the present disclosure.

FIG. 16D illustrates a perspective view of a portion of a busbar with a first portion of a container in accordance with one or more implementations of the present disclosure.

FIG. 17 illustrates a perspective view of a potting dam of a battery module in accordance with one or more implementations of the present disclosure.

FIG. 18 illustrates a perspective view of a portion of a battery module with a potting dam in accordance with one or more implementations of the present disclosure.

FIG. 19 illustrates a perspective view of a portion of a battery module with a potting dam in accordance with one or more implementations of the present disclosure.

FIG. 20 illustrates a perspective view of a portion of a battery module with multiple potting dams in accordance with one or more implementations of the present disclosure.

FIG. 21 illustrates a perspective view of a portion of a battery module with a base and a frame containing battery cells in accordance with one or more implementations of the present disclosure.

FIG. 22 illustrates a bottom view of a portion of a battery module with a base supporting a battery cell in accordance with one or more implementations of the present disclosure.

FIG. 23 illustrates a sectional view of a portion of a battery module with a base supporting a battery cell in accordance with one or more implementations of the present disclosure.

FIG. 24 illustrates a perspective view of a portion of a battery module with a base supporting battery cells in accordance with one or more implementations of the present disclosure.

FIG. 25 illustrates a perspective view of a portion of a battery module with a base supporting battery cells in accordance with one or more implementations of the present disclosure.

FIG. 26 illustrates a perspective view of a portion of a battery module with a balancing voltage and temperature (“BVT”) module in accordance with one or more implementations of the present disclosure.

FIG. 27 illustrates a top view of a portion of a battery module with a current collector assembly connected to a battery cell in accordance with one or more implementations of the present disclosure.

FIG. 28 illustrates a top view of a portion of a current collector assembly in accordance with one or more implementations of the present disclosure.

FIG. 29 illustrates a top view of a portion of a current collector assembly in accordance with one or more implementations of the present disclosure.

FIG. 30 illustrates a top view of a portion of a current collector assembly in accordance with one or more implementations of the present disclosure.

FIG. 31 illustrates a top view of a portion of a current collector assembly in accordance with one or more implementations of the present disclosure.

FIG. 32 illustrates a top view of a portion of a current collector assembly in accordance with one or more implementations of the present disclosure.

FIG. 33 illustrates a top view of a portion of a current collector assembly in accordance with one or more implementations of the present disclosure.

FIG. 34 illustrates a sectional view of a portion of a current collector assembly and a voltage sensing assembly in accordance with one or more implementations of the present disclosure.

FIG. 35 illustrates a sectional view of a portion of a current collector assembly in accordance with one or more implementations of the present disclosure.

FIG. 36 illustrates a perspective view of a portion of a battery module with a current collector assembly and a frame layered on top of one another and above battery cells in accordance with one or more implementations of the present disclosure.

FIG. 37 illustrates a sectional view of a portion of a battery module with a cover, a current collector assembly, and a frame that are aligned with a tapered tool in accordance with one or more implementations of the present disclosure.

FIG. 38 illustrates a flow diagram showing an example of a process that may be performed for assembling a battery module in accordance with one or more implementations of the present disclosure.

FIG. 39 illustrates a flow diagram showing an example of a process that may be performed for assembling a battery module in accordance with one or more implementations of the present disclosure.

FIG. 40 illustrates a perspective view of a facility for assembling a battery module in accordance with one or more implementations of the present disclosure.

FIG. 41 illustrates a top view of a facility for assembling a battery module in accordance with one or more implementations of the present disclosure.

FIG. 42 illustrates a flow diagram showing an example of a process that may be performed for assembling a battery module in accordance with one or more implementations of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

A battery module may be provided with features to support and protect components thereof from external stress and from certain electrical conditions. In particular, a battery module can be provided with components that direct forces away from electrical connection regions, such as at terminals of a battery cell. Such forces can be directed toward other structures that do not define electrical connection regions. A battery module can also be provided with features, such as a series busbar that electrically connects sets of battery cells, that enhance protections from certain electrical conditions. An assembly for such a battery module can provide guidance to align and secure assembled components and to retain them with a potting material during assembly.

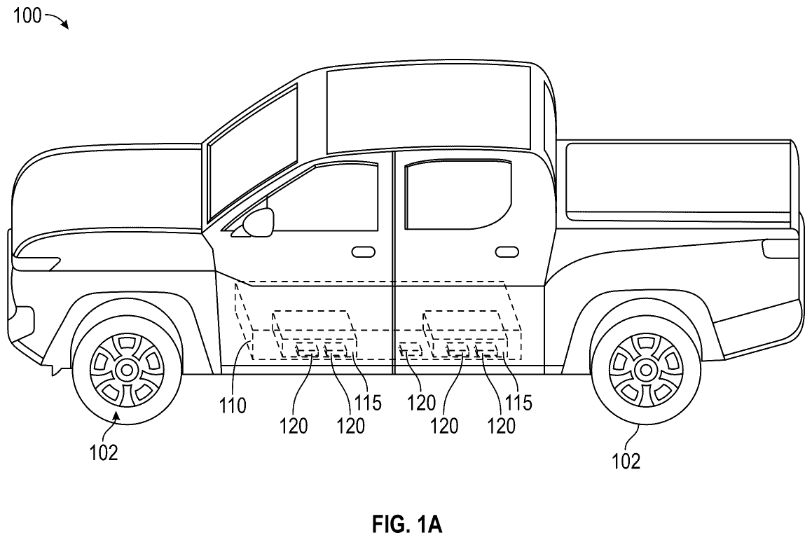

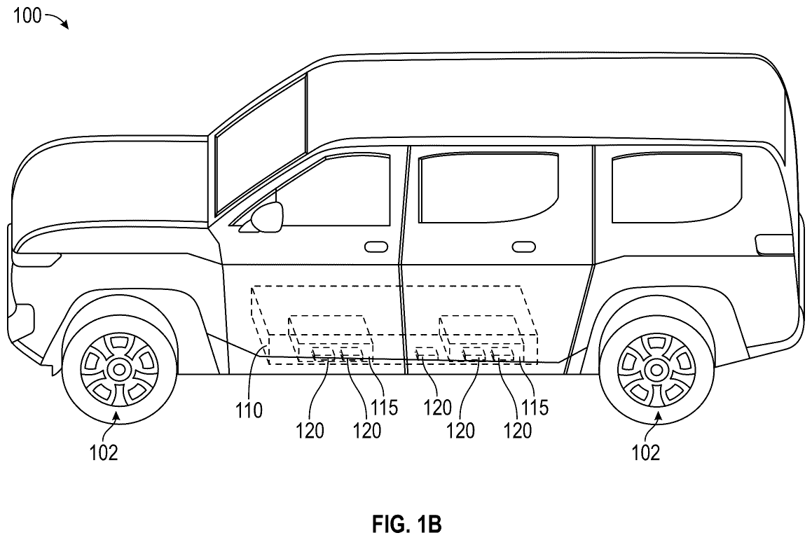

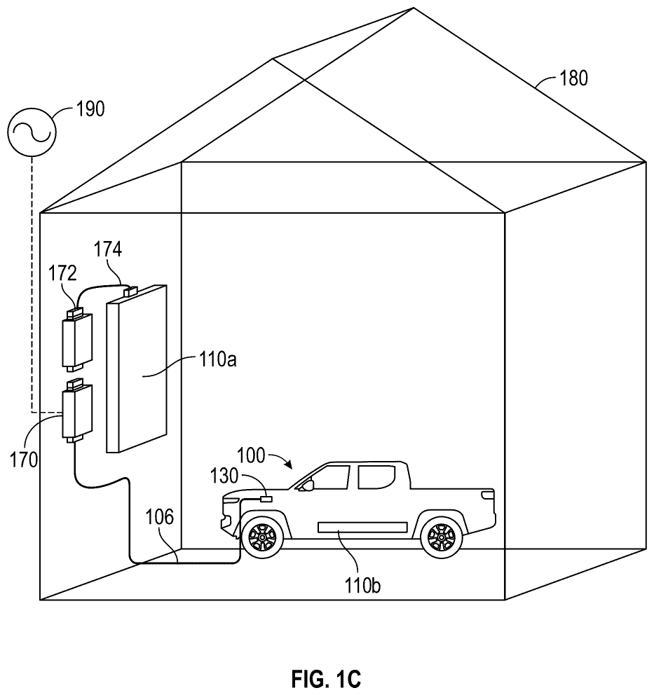

FIG. 1A illustrates an example implementation of a moveable apparatus as described herein. In the example of FIG. 1A, a moveable apparatus is implemented as a vehicle 100. As shown, the vehicle 100 may include one or more battery packs, such as battery pack 110. The battery pack 110 may be coupled to one or more electrical systems of the vehicle 100 to provide power to the electrical systems.

In some embodiments, the vehicle 100 may be an electric vehicle having one or more electric motors that drive the wheels 102 of the vehicle 100 using electric power from the battery pack 110. In some embodiments, the vehicle 100 may also, or alternatively, include one or more engines, or motors, including chemically-powered engines, such as a gas-powered engine or a fuel cell powered motor. For example, In some embodiments, the vehicle 100 includes one or more electric motors, and the vehicle 100 takes the form of a fully electric or partially electric (e.g., hybrid or plug-in hybrid) vehicle.

In the example of FIG. 1A, the vehicle 100 is implemented as a truck (e.g., a pickup truck) having a battery pack 110. As shown, the battery pack 110 may include one or more battery modules 115, which may include one or more battery cells 120. As shown in FIG. 1A, the battery pack 110 may also, or alternatively, include one or more battery cells 120 mounted directly in the battery pack 110 (e.g., in a cell-to-pack configuration). In some embodiments, the battery pack 110 may be provided without the battery modules 115 and with the battery cells 120 mounted directly in the battery pack 110 (e.g., in a cell-to-pack configuration) and/or in other battery units that are installed in the battery pack 110. The battery pack 110 may include multiple energy storage devices that can be arranged into such as battery modules or battery units. A battery unit or module can include an assembly of cells that can be combined with other elements (e.g., structural frame, thermal management devices) that can protect the assembly of cells from heat, shock and/or vibrations.

Each of the battery cells 120 may be included a battery, a battery unit, a battery module and/or a battery pack to power components of the vehicle 100. For example, a battery cell housing of the battery cells 120 can be disposed in the battery module 115, the battery pack 110, a battery array, or other battery unit installed in the vehicle 100.

As discussed in further detail hereinafter, the battery cells 120 may be provided with a battery cell housing that can be provided with any of various outer shapes. The battery cell housing may be a rigid housing in some implementations (e.g., for cylindrical or prismatic battery cells). The battery cell housing may also, or alternatively, be formed as a pouch or other flexible or malleable housing for the battery cell in some implementations. In various other implementations, the battery cell housing can be provided with any other suitable outer shape, such as a triangular outer shape, a square outer shape, a rectangular outer shape, a pentagonal outer shape, a hexagonal outer shape, or any other suitable outer shape. In some implementations, the battery pack 110 may not include modules (e.g., the battery pack may be module-free). For example, the battery pack 110 can have a module-free or cell-to-pack configuration in which the battery cells 120 are arranged directly into the battery pack 110 without assembly into a battery module 115. In some embodiments, the vehicle 100 may include one or more busbars, electrical connectors, or other charge collecting, current collecting, and/or coupling components to provide electrical power from the battery pack 110 to various systems or components of the vehicle 100. In some embodiments, the vehicle 100 may include control circuitry such as a power stage circuit that can be used to convert DC power from the battery pack 110 into AC power for one or more components and/or systems of the vehicle (e.g., including one or more power outlets of the vehicle). The power stage circuit can be provided as part of the battery pack 110 or separately from the battery pack 110 within the vehicle 100.

FIG. 1B illustrates another implementation in which the vehicle 100 is implemented as a sport utility vehicle (SUV), such as an electric sport utility vehicle. In the example of FIG. 1B, the vehicle 100 may include a cargo storage area that is enclosed within the vehicle 100 (e.g., behind a row of seats within a cabin of the vehicle 100). In other implementations, the vehicle 100 may be implemented as another type of electric truck, an electric delivery van, an electric automobile, an electric car, an electric motorcycle, an electric scooter, an electric bicycle, an electric passenger vehicle, an electric passenger or commercial truck, a hybrid vehicle, an aircraft, a watercraft, and/or any other movable apparatus having a battery pack 110 (e.g., a battery pack or other battery unit that powers the propulsion or drive components of the moveable apparatus).

In some embodiments, the battery pack 110, battery modules 115, battery cells 120, and/or any other battery unit as described herein may also, or alternatively, be implemented as an electrical power supply and/or energy storage system in a building, such as a residential home or commercial building. For example, FIG. 1C illustrates an example in which a battery pack 110a is implemented in a building 180. The building 180 may be a residential building, a commercial building, or any other building. As shown, In some embodiments, the battery pack 110a may be mounted to a wall of the building 180.

As shown, the battery pack 110a that is installed in the building 180 may be coupled (e.g., electrically coupled) to the battery pack 110b in the vehicle 100, such as via a cable/connector 106 that can be connected to a charging port 130 of the vehicle 100, an electric vehicle supply equipment 170 (EVSE), a power stage circuit 172, and/or a cable/connector 174. For example, the cable/connector 106 may be coupled to the EVSE 170, which may be coupled to the battery pack 110a via the power stage circuit 172, and/or may be coupled to an external power source 190. In this way, either the external power source 190 or the battery pack 110a may be used as an external power source to charge the battery pack 110b in some use cases. In some embodiments, the battery pack 110a may also, or alternatively, be coupled (e.g., via a cable/connector 174, the power stage circuit 172, and the EVSE 170) to the external power source 190. The external power source 190 may take the form of a solar power source, a wind power source, and/or an electrical grid of a city, town, or other geographic region (e.g., electrical grid that is powered by a remote power plant). During, for example, instances when the battery pack 110b is not coupled to the battery pack 110a, the battery pack 110a may couple (e.g., using the power stage circuit 172) to the external power source 190 to charge up and store electrical energy. In some use cases, this stored electrical energy in the battery pack 110a may later be used to charge the battery pack 110b (e.g., during times when solar power or wind power is not available, in the case of a regional or local power outage for the building 180, and/or during a period of high rates for access to the electrical grid).

In some embodiments, the power stage circuit 172 may electrically couple the battery pack 110a to an electrical system of the building 180. For example, the power stage circuit 172 may convert DC power from the battery pack 110a into AC power for one or more loads in the building 180. Exemplary loads coupled, via one or more electrical outlets coupled, to the battery pack 110a may include one or more lights, lamps, appliances, fans, heaters, air conditioners, and/or any other electrical components or electrical loads. The power stage circuit 172 may include control circuitry that is operable to switchably couple the battery pack 110a between the external power source 190 and one or more electrical outlets and/or other electrical loads in the electrical system of the building 180. In some embodiments, the vehicle 100 may include a power stage circuit (not shown in FIG. 1C) that can be used to convert power received from the EVSE 170 to DC power that is used to power/charge the battery pack 110b, and/or to convert DC power from the battery pack 110 into AC power for one or more electrical systems, components, and/or loads of the vehicle 100.

In one or more use cases, the battery pack 110a may be used as a source of electrical power for the building 180, such as during times when solar power or wind power is not available, in the case of a regional or local power outage for the building 180, and/or during a period of high rates for access to the electrical grid, as non-limiting examples. In one or more other use cases, the battery pack 110b may be used to charge the battery pack 110a and/or to power the electrical system of the building 180 (e.g., in a use case in which the battery pack 110a is low on or out of stored energy and in which solar power or wind power is not available, a regional or local power outage occurs for the building 180, and/or a period of high rates for access to the electrical grid occurs, as non-limiting examples.

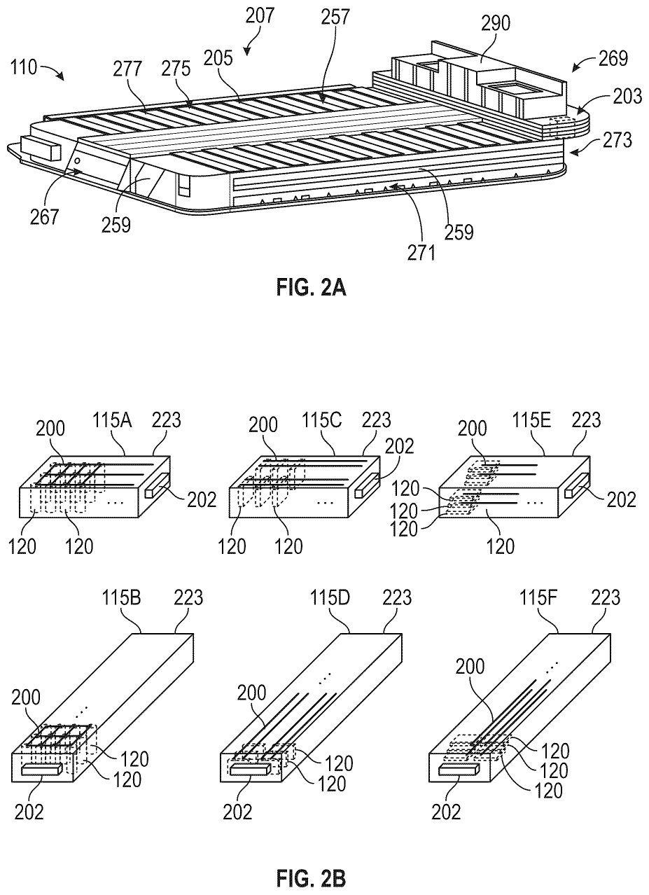

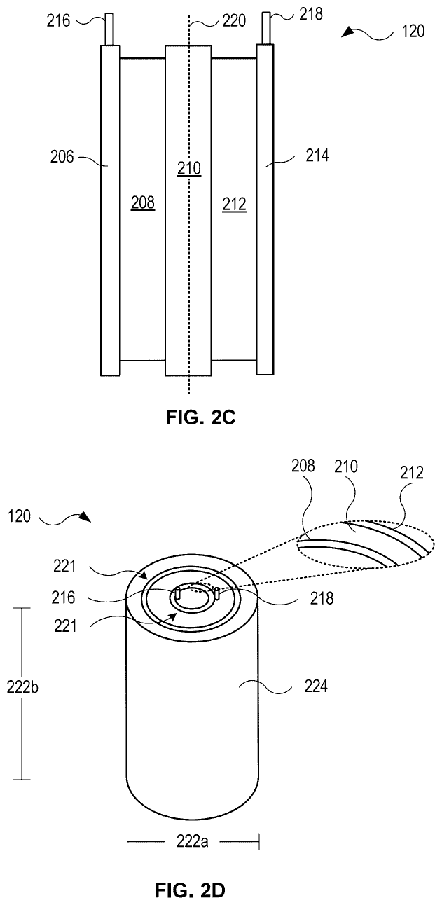

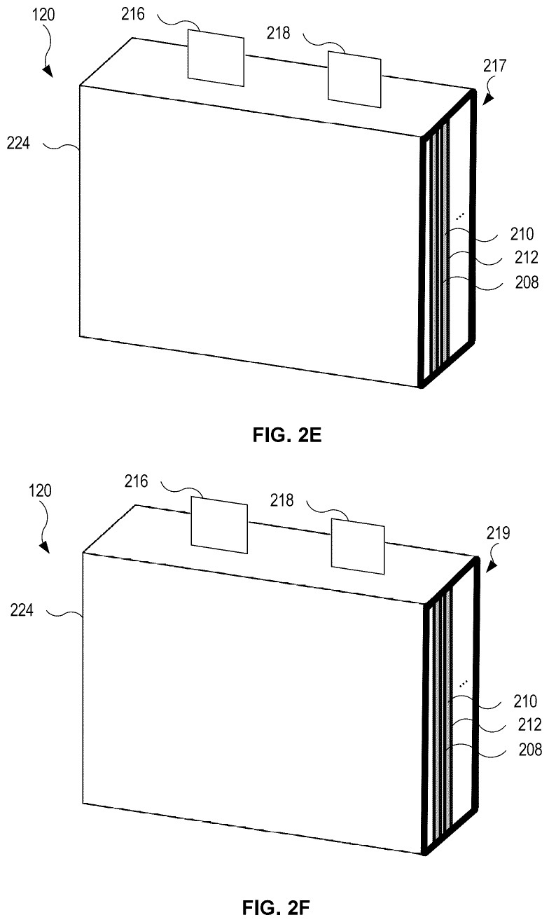

FIG. 2A depicts an example battery pack 110, in accordance with one or more implementations. As shown, the battery pack 110 may include an energy volume enclosure 205 (e.g., a battery pack housing, sometimes referred to herein as an enclosure). For example, the energy volume enclosure 205 may house or enclose an energy volume 207 for the battery pack 110, the energy volume 207 including one or more battery modules 115 and/or one or more battery cells 120, and/or other battery pack components. In one or more implementations, the energy volume enclosure 205 may include or form a shielding structure on an outer surface thereof (e.g., a bottom thereof and/or underneath one or more battery module 115, battery units, batteries, and/or battery cells 120) to protect the battery module 115, battery units, batteries, and/or battery cells 120 from external conditions (e.g., if the battery pack 110 is installed in a vehicle 100 and the vehicle 100 is driven over rough terrain, such as off-road terrain, trenches, rocks, rivers, streams, etc.).

Battery pack 110 may include, within the energy volume 207 and the energy volume enclosure 205, multiple battery cells 120 (e.g., directly installed within the battery pack 110, or within batteries, battery units, battery subassemblies, and/or battery modules 115 as described herein) and/or battery modules 115, and one or more conductive coupling elements for coupling a voltage generated by the battery cells 120 to a power-consuming component, such as the vehicle 100 and/or an electrical system of a building 180. For example, the conductive coupling elements may include internal connectors and/or contactors that couple together multiple battery cells 120, battery units, batteries, battery subassemblies, and/or multiple battery modules 115 within the energy volume enclosure 205 to generate a desired output voltage for the battery pack 110.

As shown, the battery pack 110 may also include a modular electrical component assembly 290 (e.g., including a modular electronic component enclosure or a modular electrical component enclosure) mounted to the energy volume enclosure 205. In one or more implementations, the modular electrical component assembly 290 may include one or more of the conductive coupling elements for routing power from the battery cells 120 and/or battery modules 115 within the energy volume enclosure 205 (e.g., within the energy volume 207) to one or more external connection ports, such as an electrical contact 203 (e.g., a high voltage terminal, port, or connector). For example, an electrical cable or harness may be connected between the electrical contact 203 and an electrical system of the vehicle 100 or the building 180, to provide electrical power to the vehicle 100 or the building 180. The energy volume enclosure 205 may have a front end 267 and a rear end 269. In one or more implementations, when the battery pack 110 is installed in the vehicle 100, the battery pack 110 may be arranged with the front end 267 closer to the front end 131 of the vehicle and the rear end 269 closer to the rear end 133 of the vehicle. As shown, the modular electrical component assembly 290 may be mounted to the energy volume enclosure 205 (e.g., to a lid 277 of the energy volume enclosure 205) at or near the rear end 269 in one or more implementations.

In one or more implementations, the battery pack 110 may include one or more additional features, such as thermal control structures (e.g., cooling lines and/or plates and/or heating lines and/or plates). For example, thermal control structures may couple thermal control structures and/or fluids to the battery modules 115, battery units, batteries, and/or battery cells 120 within the energy volume enclosure 205, such as by distributing fluid through the battery pack 110.

For example, the thermal control structures may form a part of a thermal/temperature control or heat exchange system that includes one or more thermal components such as plates or bladders that are disposed in thermal contact with one or more battery modules 115 and/or battery cells 120 disposed within the energy volume enclosure 205. For example, a thermal component may be positioned in contact with one or more battery modules 115, battery units, batteries, and/or battery cells 120 within the energy volume enclosure 205. In one or more implementations, the battery pack 110 may include one or multiple thermal control structures and/or other thermal components for each of several top and bottom battery module pairs. As shown, the battery pack 110 may include an electrical contact 203 (e.g., a high voltage connector or port) by which an external load (e.g., the vehicle 100 or an electrical system of the building 180) may be electrically coupled to the battery modules and/or battery cells in the battery pack 110.

As shown, the energy volume enclosure 205 of the battery pack 110 may include a lid 277. For example, the lid 277 may cover and extend over one or more battery modules 115, battery cells 120, and/or other battery subassemblies within the energy volume enclosure 205. In the example of FIG. 2A, the lid 277 may be a deep-drawn structure that forms a top 257, and one or more sidewalls 259 (e.g., four sidewalls), of the energy volume enclosure 205. As discussed in further detail hereinafter, the energy volume enclosure 205 may also include a tray or other housing structure (e.g., at the bottom of the energy volume enclosure) that interfaces with the lid 277 to enclose one or more battery modules 115, battery cells 120, and/or other battery subassemblies within the energy volume enclosure 205 (e.g., within a space defined by the top 257 and the sidewalls 259 of the lid 277). For example, the energy volume enclosure 205 may include a tray panel that is removable to expose an opening in the bottom of the lid 277.

In the example of FIG. 2A, the lid 277 is provided with ribbing 275 (e.g., for additional strength). In the example of FIG. 2A, the battery pack 110 includes one or more mounting features 273 (e.g., for mounting the battery pack 110 to one or more body structures of a vehicle, such as the vehicle 100). As shown in FIG. 2A, and as discussed in further detail hereinafter, the energy volume enclosure 205 may include one or more sidewall structures 271. The sidewall structures 271 may be attached to, and/or extend long, a sidewall 259 of the lid 277, and may provide impact absorption and/or redistribution functions to distribute energy from a side impact to the battery pack 110 (e.g., from a side impact to a vehicle 100) away from and/or around the one or more battery modules 115, battery cells 120, and/or other battery subassemblies within the energy volume enclosure 205.

FIG. 2B depicts various examples of battery modules 115 that may be disposed in the battery pack 110 (e.g., within the energy volume enclosure 205 of FIG. 2A). In the example of FIG. 2B, a battery module 115A is shown that includes a battery module housing 223 having a rectangular cuboid shape with a length that is substantially similar to its width. In this example, the battery module 115A includes multiple battery cells 120 implemented as cylindrical battery cells. In this example, the battery module 115A includes rows and columns of cylindrical battery cells that are coupled together by an interconnect structure 200 (e.g., a current connector assembly or CCA). For example, the interconnect structure 200 may couple together the positive terminals of the battery cells 120, and/or couple together the negative battery terminals of the battery cells 120. As shown, the battery module 115A may include a charge collector or busbar 202. For example, the busbar 202 may be electrically coupled to the interconnect structure 200 to collect the charge generated by the battery cells 120 to provide a high voltage output from the battery module 115A.

FIG. 2B also shows a battery module 115B having an elongate shape, in which the length of the battery module housing 223 (e.g., extending along a direction from a front end of the battery pack 110 to a rear end of the battery pack 110 when the battery module 115B is installed in the battery pack 110) is substantially greater than a width (e.g., in a transverse direction to the direction from the front end of the battery pack 110 to the rear end of the battery pack 110 when the battery module 115B is installed in the battery pack 110) of the battery module housing 223. For example, one or more battery modules 115B may span the entire front-to-back length of a battery pack within the energy volume enclosure 205. As shown, the battery module 115B may also include a busbar 202 electrically coupled to the interconnect structure 200. For example, the busbar 202 may be electrically coupled to the interconnect structure 200 to collect the charge generated by the battery cells 120 to provide a high voltage output from the battery module 115B.

In the implementations of battery module 115A and battery module 115B, the battery cells 120 are implemented as cylindrical battery cells. However, in other implementations, a battery module may include battery cells having other form factors, such as a battery cells having a right prismatic outer shape (e.g., a prismatic cell), or a pouch cell implementation of a battery cell. As an example, FIG. 2B also shows a battery module 115C having a battery module housing 223 having a rectangular cuboid shape with a length that is substantially similar to its width and including multiple battery cells 120 implemented as prismatic battery cells. In this example, the battery module 115C includes rows and columns of prismatic battery cells that are coupled together by an interconnect structure 200 (e.g., a current collector assembly or CCA). For example, the interconnect structure 200 may couple together the positive terminals of the battery cells 120 and/or couple together the negative battery terminals of the battery cells 120. As shown, the battery module 115C may include a charge collector or busbar 202. For example, the busbar 202 may be electrically coupled to the interconnect structure 200 to collect the charge generated by the battery cells 120 to provide a high voltage output from the battery module 115C.

FIG. 2B also shows a battery module 115D including prismatic battery cells and having an elongate shape, in which the length of the battery module housing 223 (e.g., extending along a direction from a front end of the battery pack 110 to a rear end of the battery pack 110 when the battery module 115D is installed in the battery pack 110) is substantially greater than a width (e.g., in a transverse direction to the direction from the front end of the battery pack 110 to the rear end of the battery pack 110 when the battery module 115D is installed in the battery pack 110) of the battery module housing 223. For example, one or more battery modules 115D having prismatic battery cells may span the entire front-to-back length of a battery pack within the energy volume enclosure 205. As shown, the battery module 115D may also include a busbar 202 electrically coupled to the interconnect structure 200. For example, the busbar 202 may be electrically coupled to the interconnect structure 200 to collect the charge generated by the battery cells 120 to provide a high voltage output from the battery module 115D.

As another example, FIG. 2B also shows a battery module 115E having a battery module housing 223 having a rectangular cuboid shape with a length that is substantially similar to its width and including multiple battery cells 120 implemented as pouch battery cells. In this example, the battery module 115C includes rows and columns of pouch battery cells that are coupled together by an interconnect structure 200 (e.g., a current collector assembly or CCA). For example, the interconnect structure 200 may couple together the positive terminals of the battery cells 120 and couple together the negative battery terminals of the battery cells 120. As shown, the battery module 115E may include a charge collector or busbar 202. For example, the busbar 202 may be electrically coupled to the interconnect structure 200 to collect the charge generated by the battery cells 120 to provide a high voltage output from the battery module 115E.

FIG. 2B also shows a battery module 115F including pouch battery cells and having an elongate shape in which the length of the battery module housing 223 (e.g., extending along a direction from a front end of the battery pack 110 to a rear end of the battery pack 110 when the battery module 115E is installed in the battery pack 110) is substantially greater than a width (e.g., in a transverse direction to the direction from the front end of the battery pack 110 to the rear end of the battery pack 110 when the battery module 115E is installed in the battery pack 110) of the battery module housing 223. For example, one or more battery modules 115E having pouch battery cells may span the entire front-to-back length of a battery pack within the energy volume enclosure 205. As shown, the battery module 115E may also include a busbar 202 electrically coupled to the interconnect structure 200. For example, the busbar 202 may be electrically coupled to the interconnect structure 200 to collect the charge generated by the battery cells 120 to provide a high voltage output from the battery module 115E.

In various implementations, a battery pack 110 may be provided with one or more of any of the battery modules 115A, 115B, 115C, 115D, 115E, and 115F. In one or more other implementations, a battery pack 110 may be provided without battery modules 115 (e.g., in a cell-to-pack implementation). In one or more implementations, a battery pack 110 may be provided with three elongated battery modules (e.g., three of battery modules 115B, 115D, and/or 115F).

In one or more implementations, multiple battery modules 115 in any of the implementations of FIG. 2B may be coupled (e.g., in series) to a current collector of the battery pack 110. In one or more implementations, the current collector may be coupled, via a high voltage harness, to one or more external connectors (e.g., electrical contact 203) on the battery pack 110. In one or more implementations, the battery pack 110 may be provided without any battery modules 115. For example, the battery pack 110 may have a cell-to-pack configuration in which battery cells 120 are arranged directly into the battery pack 110 without assembly into a battery module 115 (e.g., without including a separate battery module housing 223). For example, the battery pack 110 (e.g., the energy volume enclosure 205) may include or define a plurality of structures for positioning of the battery cells 120 directly within the energy volume enclosure 205.

FIG. 2C illustrates a cross-sectional end view of a portion of a battery cell 120. As shown, the battery cell 120 may include an anode 208, an electrolyte 210, and a cathode 212. As shown, the anode 208 may include or be electrically coupled to a first current collector 206 (e.g., a metal layer such as a layer of copper foil or other metal foil). Also, the cathode 212 may include or be electrically coupled to a second current collector 214 (e.g., a metal layer such as a layer of aluminum foil or other metal foil). The battery cell 120 may further include a terminal 216 (e.g., a negative terminal) coupled to the anode 208 (e.g., via the first current collector 206) and a terminal 218 (e.g., a positive terminal) coupled to the cathode (e.g., via the second current collector 214). In various implementations, the electrolyte 210 may take the form of a liquid electrolyte layer or a solid electrolyte layer. In some embodiments in which the electrolyte 210 is a liquid electrolyte layer, the battery cell 120 may include a separator layer 220 that separates the anode 208 from the cathode 212. In some embodiments in which the electrolyte 210 is a solid electrolyte layer, the electrolyte 210 may function as both separator layer and an electrolyte layer.

In some embodiments, the battery cell 120 may be implemented as a lithium-ion battery cell in which the anode 208 is formed from a carbonaceous material (e.g., graphite or silicon-carbon). In these implementations, lithium-ions can move from the anode 208, through the electrolyte 210, to the cathode 212 during discharge of the battery cell 120 (e.g., and through the electrolyte 210 from the cathode 212 to the anode 208 during charging of the battery cell 120). For example, the anode 208 may be formed from a graphite material that is coated on a copper foil corresponding to the first current collector 206. In these lithium-ion implementations, the cathode 212 may be formed from one or more metal oxides (e.g., a lithium cobalt oxide, a lithium manganese oxide, a lithium nickel manganese cobalt oxide (NMC), or the like) and/or a lithium iron phosphate. In an implementation in which the battery cell 120 is implemented as a lithium-ion battery cell, the electrolyte 210 may include a lithium salt in an organic solvent.

The separator layer 220 may be formed from one or more insulating materials (e.g., a polymer such as polyethylene, polypropylene, polyolefin, and/or polyamide, or other insulating materials such as rubber, glass, cellulose or the like). The separator layer 220 may prevent contact between the anode 208 and the cathode 212 and may be permeable to the electrolyte 210 and/or ions within the electrolyte 210. In some embodiments, the battery cell 120 may be implemented as a lithium polymer battery cell having a dry solid polymer electrolyte and/or a gel polymer electrolyte.

Although some examples are described herein in which the battery cell 120 is implemented as lithium-ion battery cells, the battery cell 120 may be implemented using other battery cell technologies, such as nickel-metal hydride battery cells, lead-acid battery cells, and/or ultracapacitor cells. For example, in a nickel-metal hydride battery cell, the anode 208 may be formed from a hydrogen-absorbing alloy and the cathode 212 may be formed from a nickel oxide-hydroxide. In the example of a nickel-metal hydride battery cell, the electrolyte 210 may be formed from an aqueous potassium hydroxide in one or more examples.

The battery cell 120 may be implemented as a lithium sulfur battery cell in one or more other implementations. For example, in a lithium sulfur battery cell, the anode 208 may be formed at least in part from lithium, the cathode 212 may be formed from at least in part form sulfur, and the electrolyte 210 may be formed from a cyclic ether, a short-chain ether, a glycol ether, an ionic liquid, a super-saturated salt-solvent mixture, a polymer-gelled organic media, a solid polymer, a solid inorganic glass, and/or other suitable electrolyte materials. In various implementations, the anode 208, the electrolyte 210, and the cathode 212 can be packaged into a battery cell housing having any of various shapes, and/or sizes, and/or formed from any of various suitable materials. For example, the battery cell 120 may include a cylindrical, rectangular, square, cubic, flat, pouch, elongated, or prismatic outer shape.

As depicted in FIG. 2D, for example, a battery cell 120 may be implemented as a cylindrical cell. Accordingly, the battery cell 120 includes dimension 222a (e.g., cylinder diameter, battery cell diameter) and a dimension 222b (e.g., cylinder length). The battery cell 120, and other battery cells described herein, may include dimensional information derived from a 4-number code. For example, In some embodiments, the battery cell 120 includes an XXYY battery cell, in which “XX” refers to the dimension 222a in millimeters (mm) and “YY” refers to the dimension in mm. Accordingly, when the battery cell 120 includes a “2170” battery cell, the dimension 222a is 21 mm and the dimensions 222b is 70 mm. Alternatively, when the battery cell 120 includes a “4680” battery cell, the dimension 222a is 46 mm and the dimensions 222b is 80 mm. The foregoing examples of dimensional characteristics for the battery cell 120 should not be construed as limiting, and the battery cell 120, and other battery cells described herein with a cylindrical form factor, may include various dimension. For example, the dimension 222a and the dimension 222b may be greater than 46 mm and 80 mm, respectively.

FIG. 2D illustrates a battery cell 120 that includes a cell housing 224 having a cylindrical outer shape. As shown in the enlarged view, the anode 208, the electrolyte 210, and the cathode 212 may be rolled into one or more windings 221. The one or more windings 221 may include one or more substantially cylindrical windings, as a non-limiting example. As shown, one or more windings 221 of the anode 208, the electrolyte 210, and the cathode 212 (e.g., and/or one or more separator layers such as separator layer 220 shown in FIG. 2C) may be disposed within the cell housing 224. For example, a separator layer may be disposed between adjacent ones of the one or more windings 221. Additionally, the battery cell 120 in the cylindrical cell implementation of FIG. 2D includes a terminal 216 and a terminal 218. The terminal 218 may include a first polarity terminal, such as a positive terminal, which is coupled to the cathode 212. The terminal 216 may include a second polarity terminal, such as a negative terminal, which is coupled to the anode 208. The terminals 216 and 218 can be made from electrically conductive materials to carry electrical current from the battery cell 120 directly or indirectly (e.g., via a current carrier assembly, a busbar, and/or other electrical coupling structures) to an electrical load, such as a component or system of a vehicle or a building shown and/or described herein. However, the cylindrical cell implementation of FIG. 2D is merely illustrative, and other implementations of the battery cells 120 are contemplated.

FIG. 2E illustrates an example in which the battery cell 120 is implemented as a prismatic cell. As shown, the battery cell 120 may include a cell housing 224 having a right prismatic outer shape. Also, one or more layers of the anode 208, the cathode 212, and the electrolyte 210 disposed therebetween may be disposed (e.g., with separator materials between the layers) within the cell housing 224. As examples, multiple layers of the anode 208, electrolyte 210, and cathode 212 can be stacked (e.g., with separator materials between each layer), or a single layer of the anode 208, electrolyte 210, and cathode 212 can be formed into a flattened spiral shape and provided in the cell housing 224. The cell housing 224 may include a cross-sectional width 217 that is relatively thick and is formed from a rigid material. For example, the cell housing 224 may be formed from a welded, stamped, deep drawn, and/or impact extruded metal sheet, such as a welded, stamped, deep drawn, and/or impact extruded aluminum sheet. The cross-sectional width 217 of the cell housing 224 may be as much as, or more than 1 millimeter (mm) to provide a rigid housing for the prismatic battery cell. In some embodiments, a terminal 216 and a terminal 218 in the prismatic cell implementation of FIG. 2E may be formed from a feedthrough conductor that is insulated from the cell housing 224 (e.g., a glass to metal feedthrough) as the conductor passes through to cell housing 224 to expose the terminal 216 and the terminal 218 outside the cell housing 224 in order to contact an interconnect structure (e.g., interconnect structure 213 shown in FIG. 2B). However, this implementation of FIG. 2E is also illustrative and yet other implementations of the battery cell 120 are contemplated.

FIG. 2F illustrates an example in which the battery cell 120 is implemented as a pouch cell. As shown, the battery cell 120 may include a cell housing 224 that forms a flexible or malleable pouch housing. One or more layers of the anode 208, the cathode 212, and the electrolyte 210 disposed therebetween may be disposed (e.g., with separator materials between the layers) within the cell housing 224. In the implementation of FIG. 2F, the cell housing 224 may include a cross-sectional width 219 that is relatively thin. For example, the cell housing 224 in the implementation of FIG. 2F may be formed from a flexible or malleable material (e.g., a foil, such as a metal foil, or film, such as an aluminum-coated plastic film). The cross-sectional width 219 of the cell housing 224 may be as low as, or less than, 0.1 mm, 0.05 mm, 0.02 mm, or 0.01 mm to provide flexible or malleable housing for the pouch battery cell. In some embodiments, a terminal 216 and a terminal 218 in the pouch cell implementation of FIG. 2F may be formed from conductive tabs (e.g., foil tabs) that are coupled (e.g., welded) to the anode 208 and the cathode 212 respectively, and sealed to the pouch that forms the cell housing 224 in these implementations. In the examples of FIGS. 2C, 2E, and 2F, the terminal 216 and the terminal 218 are formed on the same side (e.g., a top side) of the battery cell 120. However, this is merely illustrative and, in other implementations, the terminal 216 and the terminal 218 may formed on two different sides (e.g., opposing sides, such as a top side and a bottom side) of the battery cell 120. The terminal 216 and the terminal 218 may be formed on a same side or difference sides of the cylindrical cell of FIG. 2D in various implementations.

In some embodiments, a battery module, a battery pack, a battery unit, or any other battery may include some battery cells that are implemented as solid-state battery cells and other battery cells that are implemented with liquid electrolytes for lithium-ion or other battery cells having liquid electrolytes. In some embodiments, one or more of the battery cells may be included a battery module or a battery pack, such as to provide an electrical power supply for components of a vehicle and/or a building previously described, or any other electrically powered component or device. A cell housing of the battery cell can be disposed in the battery module, the battery pack, or installed in any of the vehicle, the building, or any other electrically powered component or device.

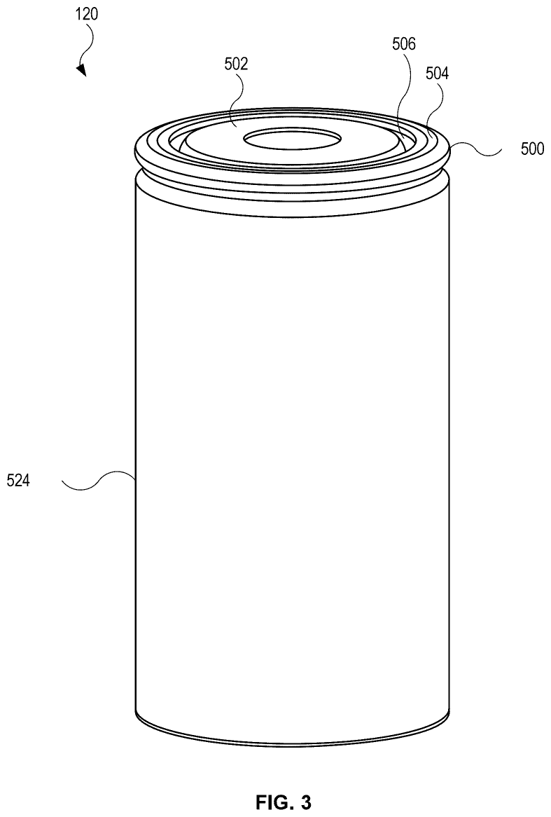

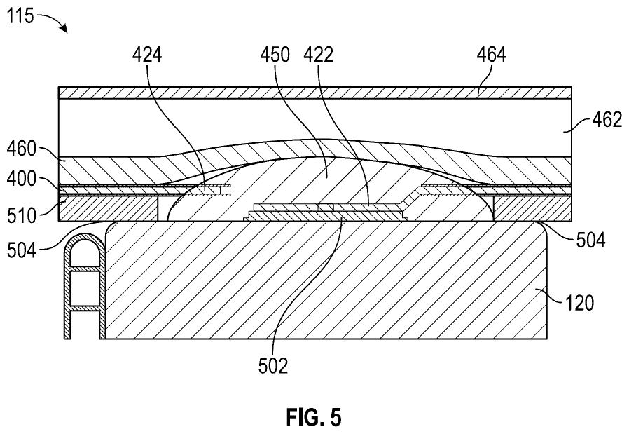

FIG. 3 illustrates a perspective view of an example of a battery cell 120, implemented as a cylindrical cell with a cylindrical cell housing 524, in accordance with one or more implementations. In the example of FIG. 5, the battery cell 120 includes a cap 500 that includes a central portion 502 and a peripheral rim 504. In some embodiments, the central portion 502 may be implemented as a terminal, such as a positive terminal of the battery cell 120. In some embodiments, the peripheral rim 504 may be implemented as a terminal, such as a negative terminal of the battery cell 120. In some embodiments, the battery cell 120 may include a gasket 506 that is disposed at least partially beneath the peripheral rim 504. For example, the gasket 506 may seal an internal cavity of the battery cell 120 (e.g., enclosed by the cylindrical cell housing 524 and the cap 500) from the external environment of the battery cell 120.

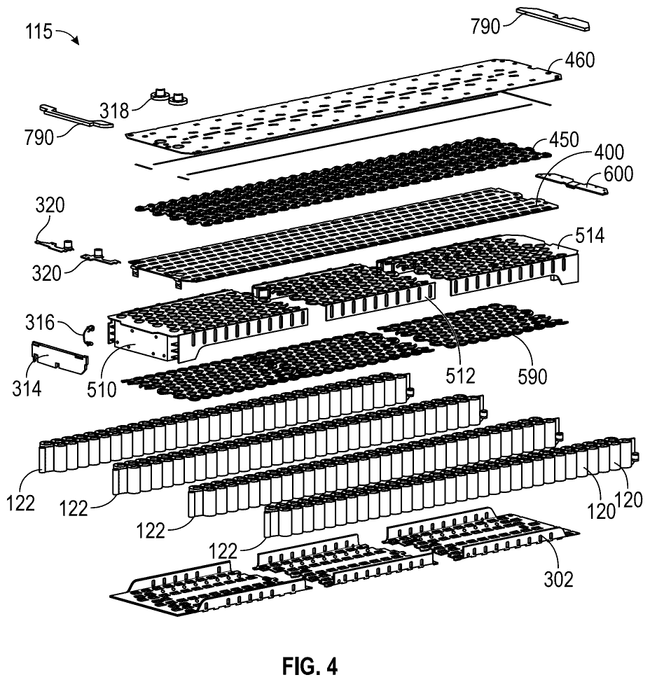

FIG. 4 illustrates a perspective exploded view of a battery module 115. The battery module 115 includes a cover 460, one or more encapsulants 450, a current collector assembly 400, a series busbar 600, one or more frames 510, 512 and/or 514, one or more separation layers 590, one or more sets 122 of battery cells 120, and a base 302.

The cover 460 may be disposed on a top of the battery module 115, and the base 302 may be disposed on a bottom of the battery module 115. The base 302 can be provided as one piece or multiple pieces. The battery cells 120 may be inserted as sets 122 into a crate structure formed by the base 302. One or more of the sets 122 of battery cells 120 can be positioned on opposing sides of a cooling element (not shown) and/or within sidewalls of the base 302.

In some embodiments, each of the frames 510, 512 and/or 514 may take the form of a monolithic unitary body (e.g., a molded body formed from plastic and/or other materials) and may include a top portion and/or sidewalls. Each of the frames 510, 512 and/or 514 can extend across at least a portion of each of the sets 122 of the battery cells 120. The frames 510, 512 and/or 514 can be joined together when secured to the battery cells 120. Where multiple frames 510, 512 and/or 514 are provided, 2 of the frames can form end portions of a joined structure, and one or more additional frames can form a midportion of the joined structure. As such, any configuration, number, and/or length of sets 122 of battery cells 120 can be engaged by a selection of a corresponding set of frames. Each set 122 can secure its battery cells 120 together along a length thereof. Furthermore, the multiple frames 510, 512 and/or 514 can be secured to one or more of the sets 122 to be secured relative to each other along the lengths of the sets 122 of the battery cells 120.

As shown in FIG. 4, a CCA 400 is provided. As discussed in further detail hereinafter, when the battery module 115 is assembled, the CCA 400 may take the form of an apparatus that connects the respective terminals of the battery cells 120 of the battery module 115 to busbar(s) 320. Several busbars may be integrated. For example, a busbar 320 (e.g., a positive busbar) may electrically couple to respective first terminals (e.g., the positive terminals) of the battery cells of the battery module 115, and a busbar 320 (e.g., a negative busbar) may electrically couple to respective second terminals (e.g., the negative terminals) of the battery cells of the battery module 115. As further shown in FIG. 4, a series busbar 600 may also be provided (e.g., on an opposing end of the frames 510, 512 and/or 514 from the end of the respective cell carriers at which the busbar(s) 320 are mounted). As used herein, the series busbar 600 can correspond to one or more of the busbars 202 illustrated in FIG. 2B.

As further shown in FIG. 4, one or more encapsulants 450 can be provided with each between the cover 460 a corresponding one of the battery cells 120. The encapsulants 450 can surround a region at which the CCA 400 connects to the terminals of the corresponding battery cells 120. The encapsulants 450 can further extend to cover and/or contact portions of the frames 510, 512, and/or 514.

The series busbar 600 can be provided to connect sets 122 of the battery cells 120 to each other. For example, the series busbar 600 can be provided to connect first sets 122 of the battery cells 120 on a first side of the cooling element 306 to second sets 122 of battery cells 120 on a second side of the cooling element 306. The series busbar 600 can be provided on top of one or more of the frames 510, 512, and/or 514. In some embodiments, the series busbar 600 is provided in a same plane that is occupied by the current collector assembly 400 and/or the encapsulants 450. Such an arrangement can allow the series busbar 600 to be surrounded by the same frame and cover that surround other components, such as the current collector assembly 400 and/or the encapsulants 450. The series busbar 600 can further be provided with one or more alignment features to align with one or more other structures, such as the frames 510, 512, and/or 514. Accordingly, the assembly can be provided with the series busbar 600 in alignment with other components of the battery module 115.

In some embodiments, a balancing voltage and temperature (“BVT”) module 314 communicatively couples to a thermistor assembly 316. The BVT module 314 may take the form a modular assembly of various electrical components to monitor and/or control components of the battery module 115. For example, the BVT module 314 may include a circuit board that is attached to a housing of the BVT module 314. The BVT module 314 may include various connectors to couple with, for example, a thermistor, a voltage sensor, and/or a communication device, as non-limiting examples. The thermistor may measure a temperature of the battery module 115 and/or a battery cell 120 thereof. The voltage sensor or balancer may sense or control voltage that flows through the battery module 115 and/or a battery cell 120 thereof. The communication device may receive, transmit, or analyze data associated with the battery module 115 and/or a battery cell 120 thereof.

In some embodiments, the BVT module 314 can include processing circuitry. Such processing circuitry may include monitoring and/or control circuitry, such as balancing temperature and voltage (BVT) circuitry. For example, the BVT circuitry may include an electrical control unit (ECU) that obtains data (e.g., voltage data, such as cell voltage data, and/or temperature data, such as one or more temperatures at one or more locations within the battery pack or energy volume) from one or more sensors within the battery pack or energy volume. The one or more sensors may be or include a voltage sensor, a current sensor, a temperature sensor, a pressure sensor, and/or a gas sensor. The BVT may process the sensor data to monitor battery cell voltages, monitor one or more temperatures, and/or execute cell balancing operations for the battery cells. In some embodiments, the BVT module 314 may provide sensor data and/or processed data derived from the sensor data to additional processing circuitry (e.g., a battery management system (“BMS”)) via a wired or wireless connection.

FIG. 5 illustrates a sectional side view of a portion of a battery module. As shown in FIG. 5, the cover 460 can extend across an encapsulant 450 that surrounds a top portion of a battery cell 120. The frame 510 can rest on the peripheral rim 504 of the battery cell 120 while leaving the central portion 502 exposed. The CCA 400 (e.g., with the first interconnect portion 422 and the second interconnect portion 424) can extend beyond the frame 510 and to the battery cell 120. The encapsulant 450 can encompass a contact region between a first interconnect portion 422 and the central portion 502 (e.g., terminal) of the battery cell 120. The encapsulant 450 can encompass a contact region between a second interconnect portion 424 and the peripheral rim 504 (e.g., terminal) of the battery cell 120. The encapsulant 450 can extend to the frame 510. The cover 460 can have a shape that accommodates the encapsulants 450. For example, the cover 460 can have a concave shape facing the battery cell 120 (e.g., and/or the encapsulant 450). By further example, the cover 460 can have a convex shape facing away from the battery cell 120. The cover 460 can rest on and/or engage the CCA 400 and/or the frame 510. The cover 460 can be substantially rigid. The cover 460 can be of a material such as a metal (e.g., steel).

In some embodiments, the cover 460 is integrally (e.g., monolithically) formed with one or more frames (e.g., frames 510, 512, and/or 514). For example, the cover and/or the frame(s) can be extruded about the CCA 400 on opposing sides thereof. The CCA 400 can provide electrical conduction within such an integrated structure.

The cover 460 can receive forces and/or other loads from above, such as from an upper layer 464 and/or through a compressible layer 462. For example, the compressible layer 462 can include a compressible material, such as a foam and/or elastic. Forces applied to the upper layer 464 can be dampened by the compressible layer 462. Forces that are applied to the cover 460 can be directed around and away from the encapsulant 450, the first interconnect portion 422, the second interconnect portion 424, and/or the central portion 502 of the battery cell 120. Instead, the forces can be directed to portions of the peripheral rim 504 of the battery cell 120 (e.g., via the CCA 400 and/or the frame 510. As such, the connection between the first interconnect portion 422 and the central portion 502 (e.g., terminal) of the battery cell 120 and between the second interconnect portion 424 and the peripheral rim 504 (e.g., terminal) of the battery cell 120 can be protected despite the forces applied to the cover 460. In some embodiments, the encapsulant 450 has a modulus of elasticity that is lower than a modulus of elasticity of the cover 460 and a modulus of elasticity of the frame 510. Where forces are transmitted to the encapsulant 450, such forces can be dampened before reaching the connection between the first interconnect portion 422 and the central portion 502 (e.g., terminal) of the battery cell 120 and between the second interconnect portion 424 and the peripheral rim 504 (e.g., terminal) of the battery cell 120. By protecting the battery cells 120 with these and/or other features, the battery module 115 and/or a battery pack containing one or more battery modules 115 can be provided at or near a floor of the vehicle cabin. For example, as the cover 460 and/or the encapsulants 450 are deemed to provide adequate protection to the battery cells 120, the thickness of other intervening structures between the battery pack and the floor of the vehicle cabin can be minimized. By further example, the amount and/or number of additional dampening materials can be reduced. Accordingly, the total height of the structure beneath the floor of the vehicle cabin can be minimized, thereby forming a final assembled product with greater space efficiency.

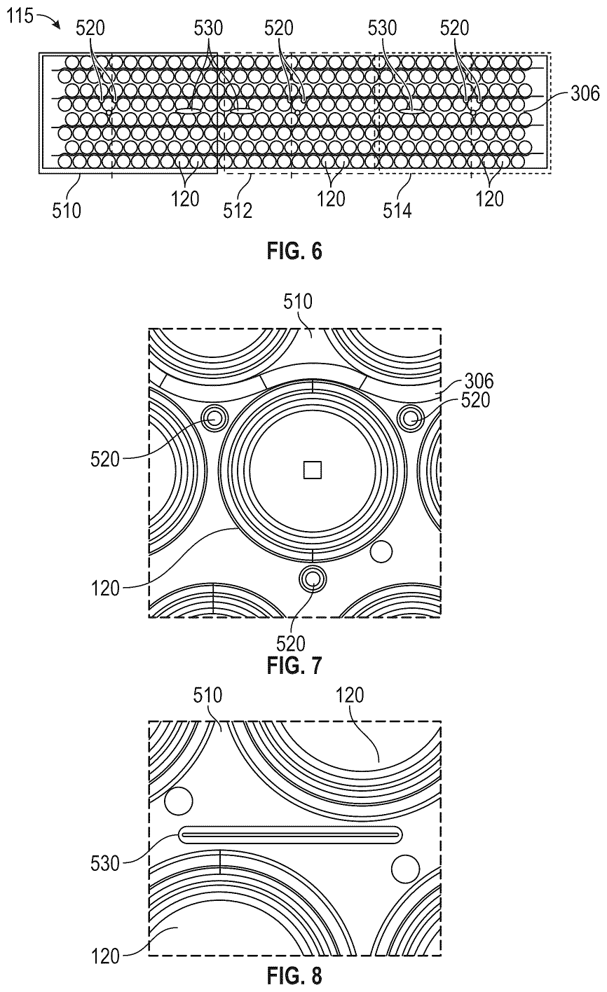

Referring now to FIG. 6-8, locating features can be provided to facilitate alignment of parts of a battery module during assembly. Each locating feature can include one or more parts and/or an arrangement of parts that form a datum. As used herein, a datum refers to one or more parts and/or an arrangement of parts that restrict relative movement of two or more components with respect to each other in one or more degrees of freedom. In some embodiments, the degrees of freedom are defined as directions along one or more axes of a coordinate system (e.g., including two opposing directions along a single axis). For example, a 2-way datum restricts relative movement of two or more components with respect to each other in two degrees of freedom, such as along two opposing directions of a common axis. By further example, a 4-way datum restricts relative movement of two or more components with respect to each other in four degrees of freedom, such as along two opposing directions in each of two different (e.g., orthogonal) axes. It should be understood that a locating feature of a given component forms a datum for another component based on an interaction with another feature of the other component. Where a single location feature interacts with multiple other components, one or more degrees of freedom can be provided in a common direction and/or along a common axis for each of the other components with respect to the locating feature.

FIG. 6 illustrates a top view of multiple frames on battery cells of a battery module. Each of the frames 510, 512, and/or 514 can include one or more locating features to engage the battery cells 120. In some embodiments, as shown in FIG. 6, first engagers 520 can form a 4-way datum, and second engagers 530 can form a 2-way datum.

FIG. 7 illustrates a bottom view of a first portion of a frame on battery cells of a battery module. As shown in FIG. 7, frame 510 can include multiple first (e.g., three or more) engagers 520 that extend between one or more battery cells 120. Each of the first engagers 520 can be formed as a pin or post that extends in parallel to a height of the battery cells 120. The first engagers 520 can be distributed about any one of the battery cells 120. Accordingly, the first engagers 520 can form a 4-way datum to restrict movement of the frame 510 with respect to the battery cells 120 in two different (e.g., orthogonal) axes.

FIG. 8 illustrates a bottom view of a second portion of a frame on battery cells of a battery module. As shown in FIG. 8, frame 510 can include a second engager 530 that extends between one or more battery cells 120. The second engager 530 can be formed as a rib that extends in parallel to a height of the battery cells 120 with a length that extends transverse to the height of the battery cells 120. The second engager 530 can be positioned between any two or more of the battery cells 120. Accordingly, the second engager 530 can form a 2-way datum to restrict movement of the frame 510 with respect to the battery cells 120 in one axis. The combination of the first engagers 520 and the second engager 530 can further restrict rotation of the frame 510 with respect to the battery cells 120.

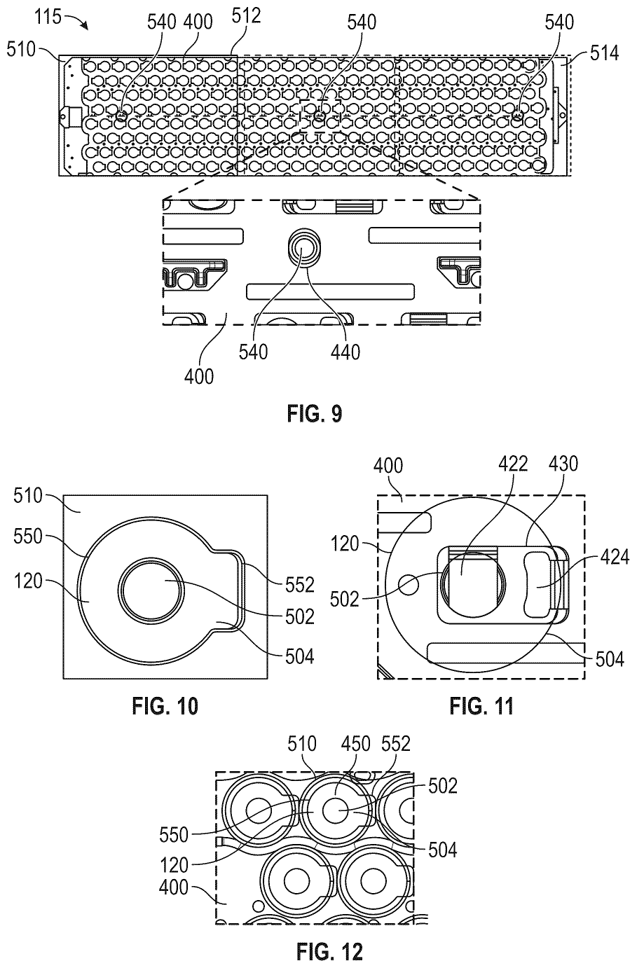

FIG. 9 illustrates a top view of a current collector assembly on a frame and battery cells of a battery module. Each of the frames 510, 512, and/or 514 can include one or more locating features to engage the CCA 400. For example, each of third engagers 540 can form a 2-way datum. As further shown in FIG. 9, each of the frames 510, 512, and/or 514 can include one or more third engagers 540 that extend into openings 440 of the CCA 400. Each of the third engagers 540 can be formed as a pin or post that extends in a direction opposite the direction of the first and second engagers. Each of the third engagers 540 can extend into a corresponding opening 440 of the CCA 400. In some embodiments, the shape, size, and/or orientation of the opening 440 allows movement of the CCA 400 in one axis and restricts movement of the CCA 400 in another (e.g., orthogonal) axis. Where the openings 440 corresponding to (e.g., overlapping) each of the frames 510, 512, and/or 514 is different (e.g., in shape, size, and/or orientation), the direction of movements allowed and restricted can be different. As such, while each of the third engagers 540 and its corresponding opening 440 can form a 2-way datum to restrict movement of the CCA 400 with respect to the frame in one axis, the combination of multiple third engagers 540 and their corresponding openings 440 can form a 4-way datum to restrict movement of the CCA 400 with respect to the frames 510, 512, and/or 514 in two axes.

Referring now to FIGS. 10-12, a frame can provide openings for accessing one or more battery cells covered thereby. FIG. 10 illustrates a top view of a portion of frame on a battery cell of a battery module. As shown in FIG. 10, the frame 510 can define an opening 550 that is aligned with portions of the battery cell 120. The opening 550 can expose the central portion 502 of the battery cell 120, which can also expose a terminal positioned thereat. The frame 510 can include structure that is aligned to overlap portions of the peripheral rim 504 of the battery cell 120. Additionally, the opening 550 can include a cutout 552 that exposes a portion of the peripheral rim 504, which can also expose a terminal positioned thereat. As such, both the central portion 502 and a portion of the peripheral rim 504 of the battery cell 120 can be exposed to provide connection at terminals thereat.

FIG. 11 illustrates a top view of a portion of a current collector assembly on the frame and the battery cell of FIG. 10. The CCA 400 connects (e.g., mechanically and electrically) with multiple battery cells 120 of a battery module. The CCA 400 defines an opening 440 that overlaps portions of the battery cell 120. A first interconnect portion 422 and a second interconnect portion 424 extend into the opening 440 of the CCA 400 and the opening of the frame for connection with the battery cell 120. The first interconnect portion 422 of the CCA 400 connects to the central portion 502 of the battery cell 120. The second interconnect portion 424 of the CCA 400 connects to the peripheral rim 504 of the battery cell 120. The first interconnect portion 422 and the second interconnect portion 424 can extend from different directions into the opening 440. While the first interconnect portion 422 can extend into the opening 550 of the frame 510, the second interconnect portion the 424 can extend into the cutout 552 that exposes a portion of the peripheral rim 504 of the battery cell 120.

FIG. 12 illustrates a top view of encapsulants on a frame and battery cells of a battery module. As shown in FIG. 12, each of the encapsulants 450 can be provided at an upper side of the corresponding battery cell 120. For example, each encapsulant 450 can cover the central portion 502 and at least a portion of the peripheral rim 504 of the corresponding battery cell 120. As such, the encapsulant 450 can extend into the opening 550, including into at least a portion of the cutout 552. The encapsulant 450 can extend to and/or overlap a portion of the frame 510 and/or the CCA 400, including interconnect portions (not shown) thereof connecting to the battery cell 120.

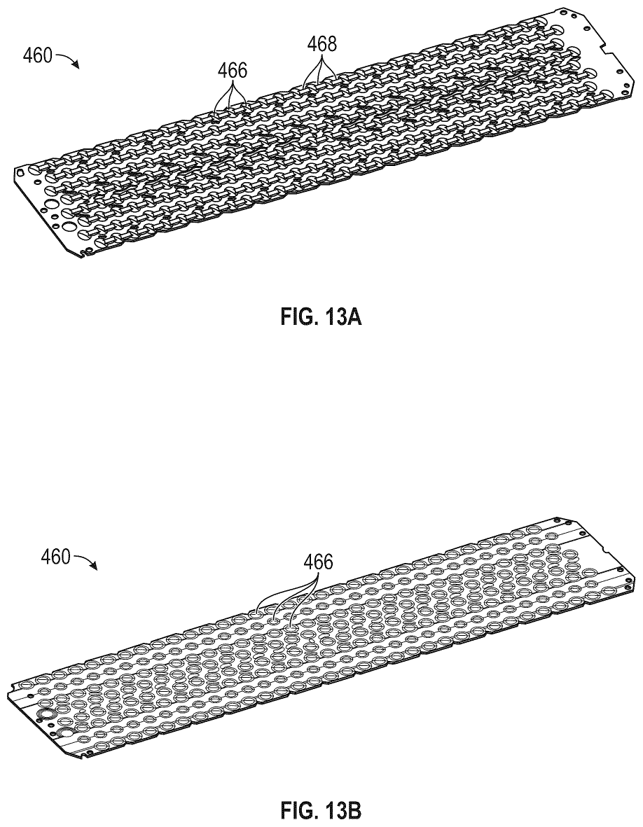

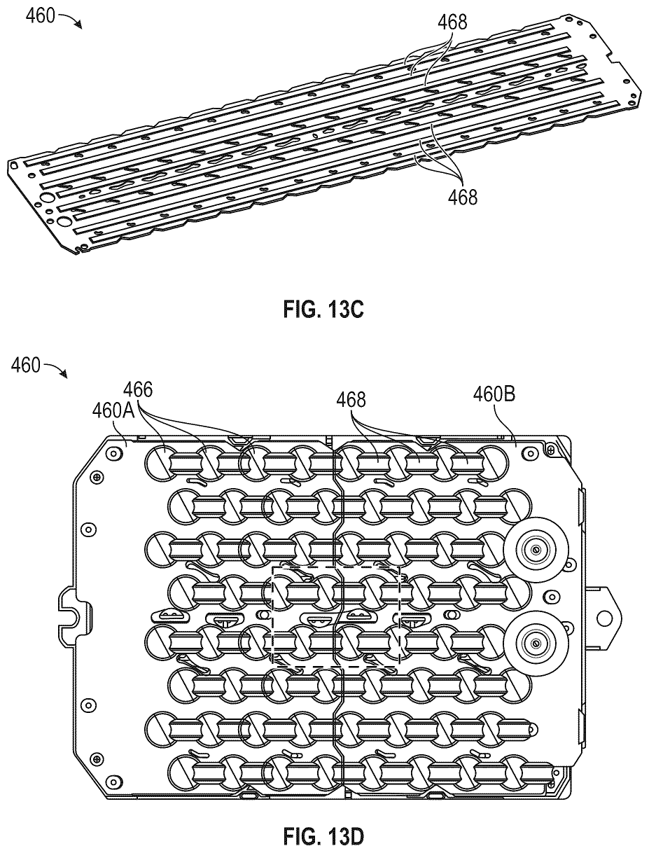

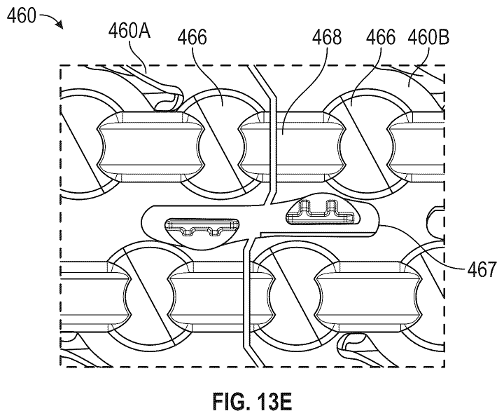

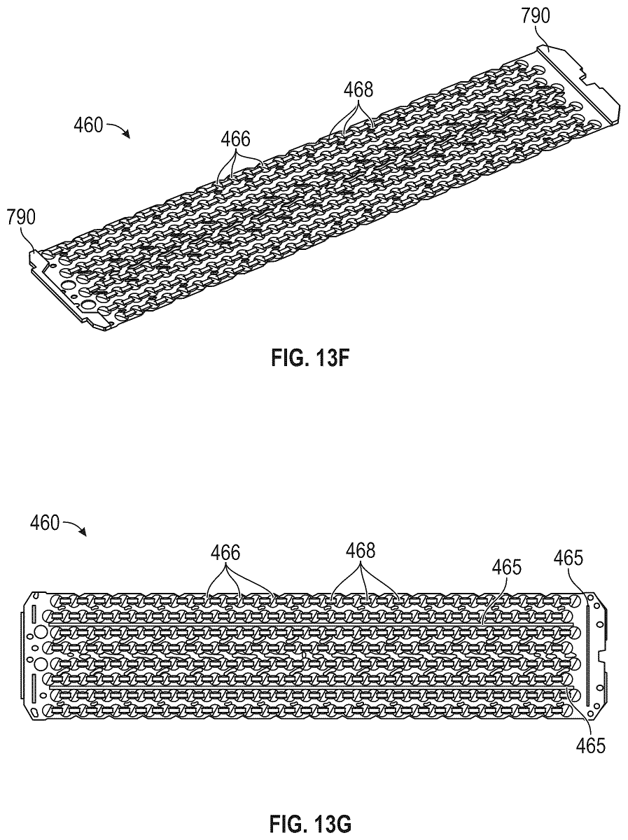

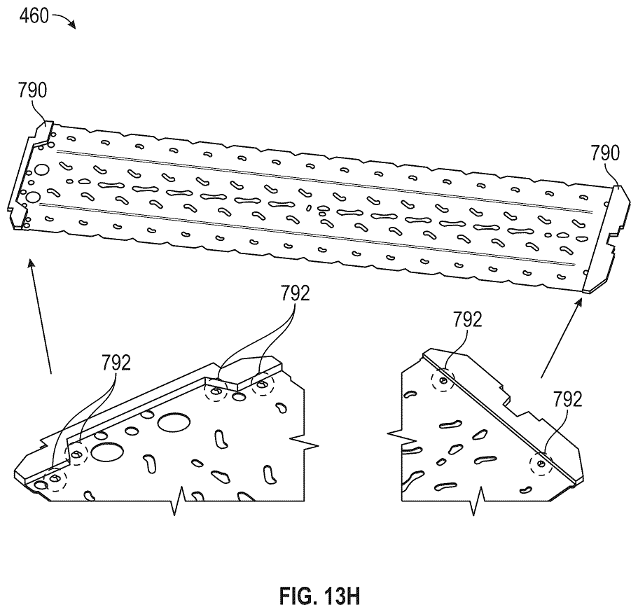

FIG. 13A-G illustrate various examples of a cover 460. In one or more embodiments, the cover 460 can be a composite protective cover with compression molded structural domes 466 and channels 468 that help dissipate loads in the Z direction (e.g., orthogonal to the surface of the cover 460) and prevent deformation of underlying battery cells, thereby preventing thermal runaway. The compression molded structural domes 466 and channels 468 can house the encapsulant adhesive to protect the welds between the battery cells and the current collector assembly.

FIG. 13A illustrates a perspective view of a cover in accordance with one or more implementations of the present disclosure. As shown in FIG. 13A, the cover 460 can include one or more domes 466, each forming a concave shape on a first side of the cover 460 and a convex shape on a second side of the cover 460. As further shown in FIG. 13A, the cover 460 can include one or more channels 468. The channels 468 can extend between and/or connect to two or more of the domes 466, such that the separate spaces that are partially encompassed by the connected domes are connected to form a continuous space.

FIG. 13B illustrates a perspective view of a cover in accordance with one or more implementations of the present disclosure. As shown in FIG. 13B, the cover 460 can include one or more domes 466, wherein the domes 466 can have a similar (e.g., same) shape and/or different shapes with respect to each other. Where the shape and/or size of individual domes 466 vary, one or more domes 466 having a common first shape and/or size can be arranged in a common first row and/or column, and one or more domes 466 having a common second shape and/or size, different from the first shape and/or size, can be arranged in a common second row and/or column. As further shown in FIG. 13B, the cover 460 can optionally omit one or more channels.

FIG. 13C illustrates a perspective view of a cover in accordance with one or more implementations of the present disclosure. As shown in FIG. 13C, the cover 460 can include one or more channels 468. The channels 468 can extend in parallel between and/or to opposing ends of the cover 460. As further shown in FIG. 13C, the cover 460 can optionally omit one or more domes.

FIGS. 13D and 13E illustrate a top view of a cover in accordance with one or more implementations of the present disclosure. The cover 460 can include multiple portions, such as first cover portion 460A and second cover portion 460B. Each of the first cover portion 460A and the second cover portion 460B can include one or more domes 466 and/or one or more channels 468. The first cover portion 460A and the second cover portion 460B can have complementary shapes at ends thereof to be joined together. For example, as shown in FIG. 13E, the cover 460 can define an opening 467 through which one or more other components of the assembly can be extend and/or be accessed. One or more openings 467 can be closed to be fully defined at one of the first cover portion 460A and the second cover portion 460B. One or more openings 467 can be open to be partially defined at one of the first cover portion 460A and the second cover portion 460B and/or a space between the first cover portion 460A and the second cover portion 460B.

FIG. 13F illustrates a perspective view of a cover in accordance with one or more implementations of the present disclosure. In some embodiments, the cover 460 can be integrated with one or more potting dams 790. For example, a potting dam 790 can be provided at one or both of opposing ends of the cover 460. By further example, multiple potting dams 790 can surround one or more domes 466 and/or one or more channels 468. The potting dams 790 can be formed (e.g., die cut) from a material such as foam. Each of the potting dams 790 can be joined to the cover 460, for example, using pressure sensitive adhesive (PSA) tape and/or another adhesive and/or securement mechanism.

FIG. 13G illustrates a bottom view of a cover in accordance with one or more implementations of the present disclosure. The cover 460 can include, for example at a bottom side thereof, an adhesive 465 for securing to an underlying structure of the assembly. For example, the cover 460 can be joined to the layers underneath using a pressure sensitive adhesive (PSA) tape and/or another adhesive and/or securement mechanism. By further example, the adhesive 465 can be provided via roll dispensing onto the cover 460. The adhesive 465 can be provided between, alongside, and/or across one or more domes 466 and/or one or more channels 468. In some embodiments, the adhesive 465 can be provided at multiple locations and/or extending in different directions to provide securement against forces that may be provided in a variety of directions. In some embodiments, the cover 460 can be joined to the layers underneath using adhesive, heat staking, push clips, welding, riveting, and/or combinations thereof.

FIG. 13H illustrates a perspective view of a cover in accordance with one or more implementations of the present disclosure. In some embodiments, the cover 460 can be integrated with one or more potting dams 790. In some embodiments, the cover 460 defines one or more clearance holes 792 at each of opposing ends thereof. Each of the clearance holes 792 can receive a boss or stud (e.g., of plastic) that is heat staked to secure the cover 460 in place by being heat staked and/or melted into a shape (e.g. a dome).

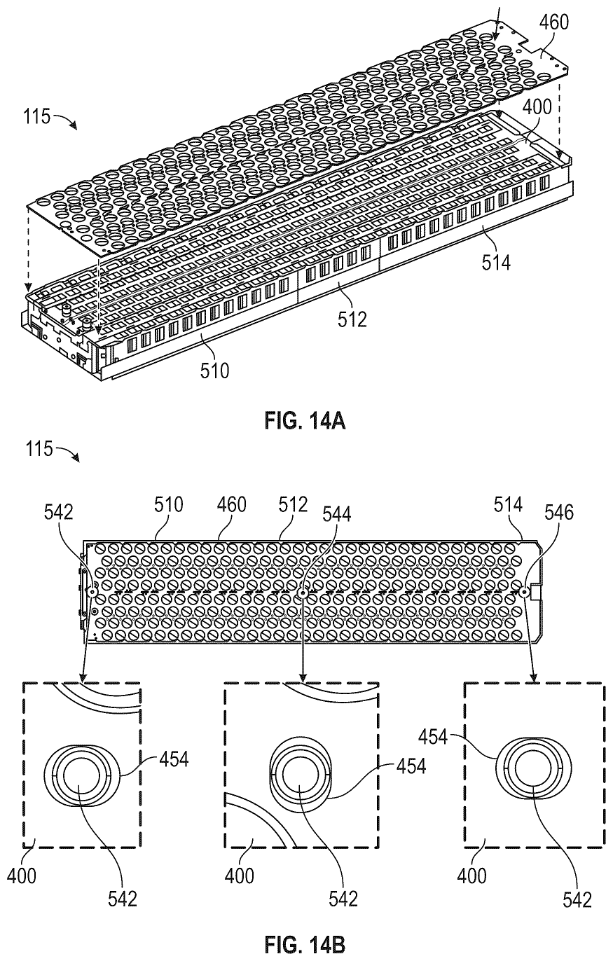

FIG. 14A illustrates an exploded perspective view of a cover above a current collector assembly of a battery module. As shown in FIG. 14A, the cover 460 can be provided over the frames 510, 512, and/or 514, the CCA 400, and/or the encapsulants.

FIG. 14B illustrates a top view of a cover on a frame of a battery module. Each of the frames 510, 512, and/or 514 can include one or more locating features to engage the cover 460. For example, each of fourth engagers 542 can form a 2-way datum. As further shown in FIG. 14B, each of the frames 510, 512, and/or 514 can include one or more fourth engagers 542 that extend into openings 472 of the cover 460. Each of the fourth engagers 542 can be formed as a pin or post that extends in a direction opposite the direction of the first and second engagers.

Each of the fourth engagers 542 can extend into a corresponding opening 454 of the cover 460. In some embodiments, the shape, size, and/or orientation of the opening 472 allows movement of the cover 460 in one axis and restricts movement of the cover 460 in another (e.g., orthogonal) axis. Where the openings 472 corresponding to (e.g., overlapping) each of the frames 510, 512, and/or 514 is different (e.g., in shape, size, and/or orientation), the direction of movements allowed and restricted can be different. As such, while each of the fourth engagers 542 and its corresponding opening 454 can form a 2-way datum to restrict movement of the cover 460 with respect to the frame in one axis, the combination of multiple fourth engagers 542 and their corresponding openings 454 can form a 4-way datum to restrict movement of the cover 460 with respect to the frames 510, 512, and/or 514 in two axes.

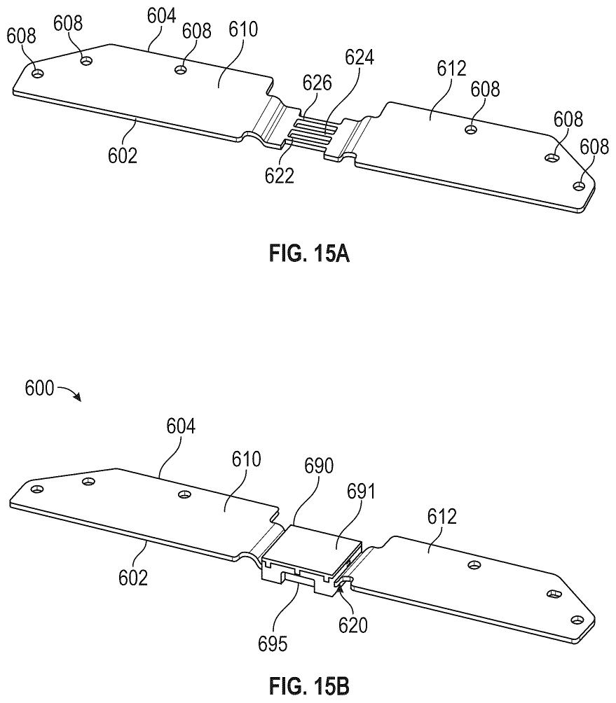

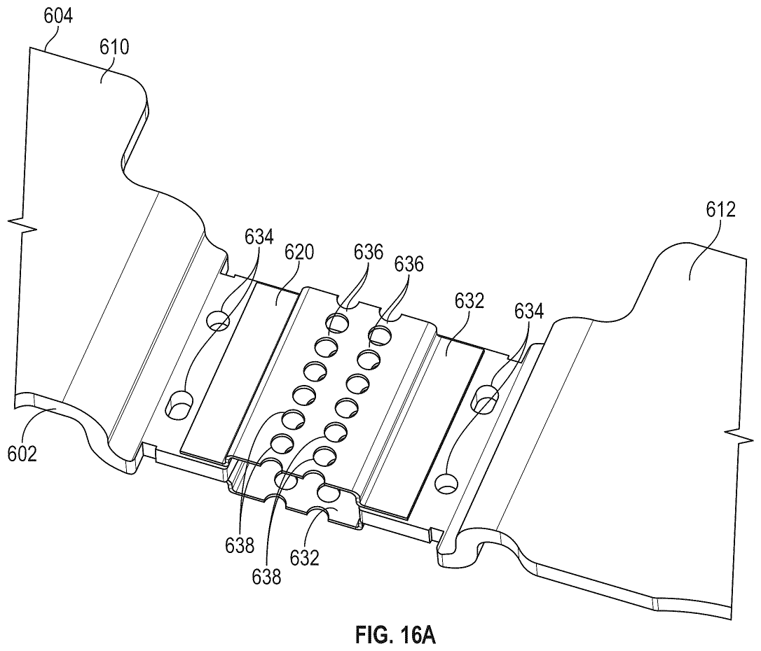

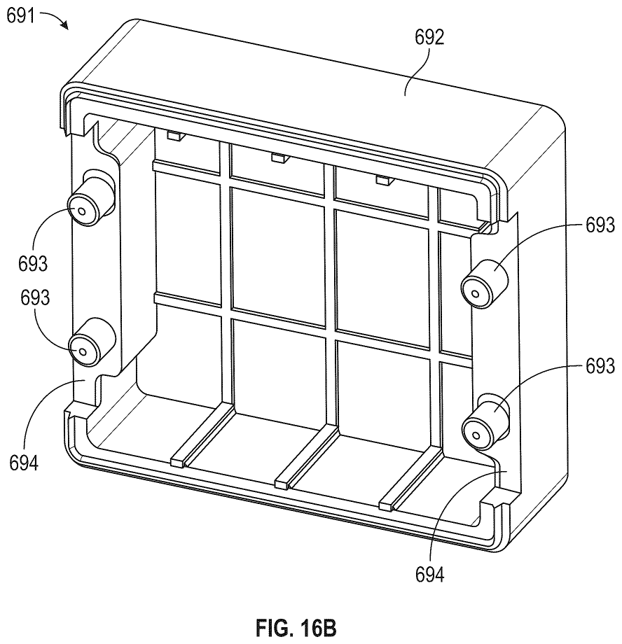

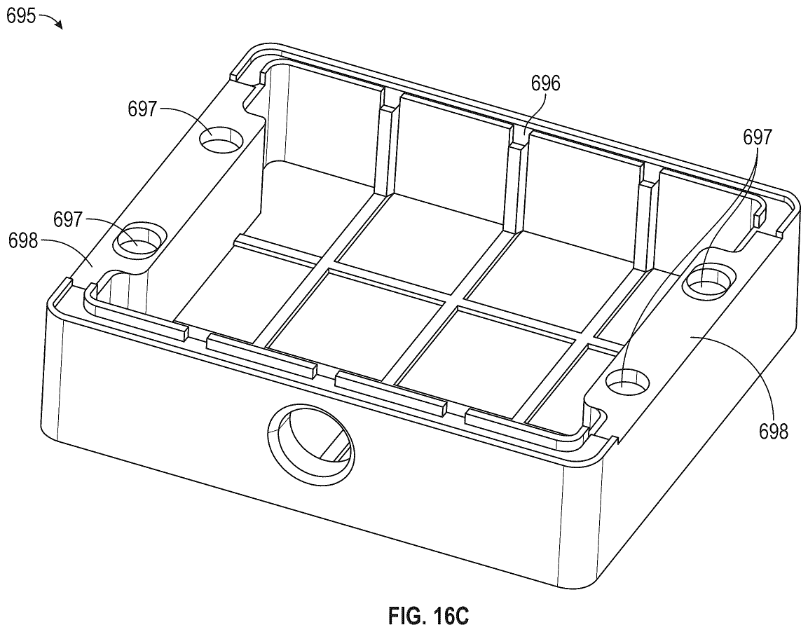

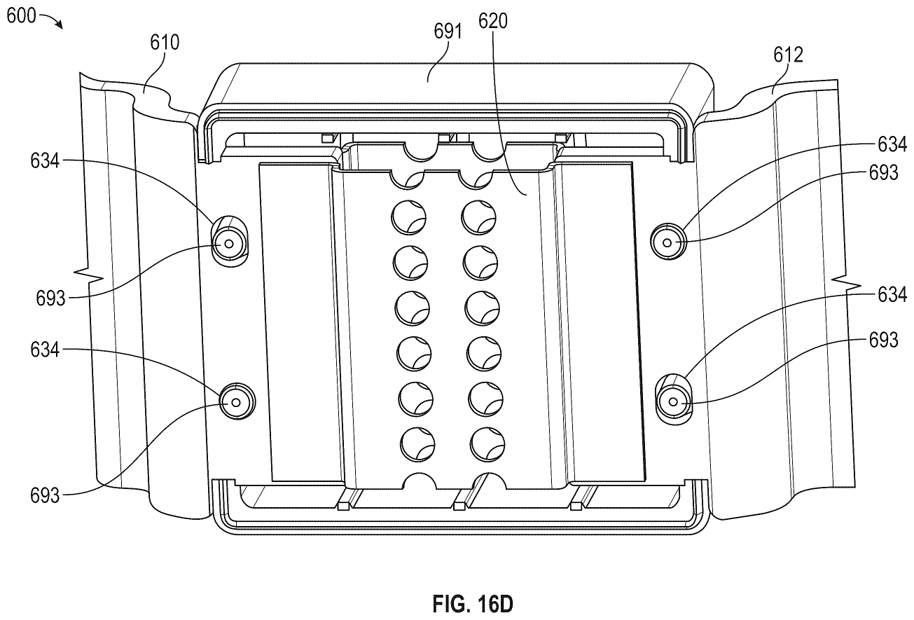

Referring now to FIG. 15A-16D, a series busbar can be provided to connect different sets (e.g., rows) of battery cells to each other. Such a series busbar can provide robust conductivity between the different sets of the battery cells while also providing one or more fuses to severe the electrical connection there between under certain conditions.

FIG. 15A illustrates a perspective view of a series busbar 600 of a battery module. As shown in FIG. 15A, the series busbar 600 includes a first terminal 610 and a second terminal 612. In some embodiments, the first terminal 610 and the second terminal 612 can include one or more alignment features 608 for receiving one or more engagers (e.g., posts, pins, extensions, and/or the like) of a frame (not shown). For example, the alignment features 608 can include one or more openings. The openings can form 2-way and/or 4-way datums with the engagers of the frame. For example, one or more of the alignment features 608 can receive the engagers of the frame and permit a limited range of motion thereof within the respective opening of the alignment features 608. The series busbar 600 can be heat staked or otherwise fixed to the frame at or near a location of the alignment features 608.

In some embodiments, the first terminal 610 can be configured to connect (e.g., mechanically and electrically) to a first set of battery cells (e.g., via a CCA), and the second terminal 612 can be configured to connect (e.g., mechanically and electrically) to a second set of battery cells (e.g., via the CCA). The series busbar 600 can further include a fuse 620, which can include multiple fuse elements 622, 624, and/or 626. The fuse 620 can connect (e.g., mechanically and electrically), in parallel, the first terminal 610 and the second terminal 612. While three fuse elements are illustrated, it will be understood that any number of fuse elements can be provided. The fuse elements 622, 624, and/or 626 provide an ability to break under excessive electrical current, thereby disconnecting the first set of battery cells from the second set of battery cells under certain conditions.

In some embodiments, each of the multiple fuse elements 622, 624, and/or 626 has a different cross-sectional dimension. As used herein, the cross-sectional dimension can be a width, thickness, height, diameter, and/or other dimension that is defined in a cross-section of the fuse elements 622, 624, and/or 626. One of the fuse elements 622, 624, and/or 626 can have a smallest cross-sectional dimension. Accordingly, the one of the fuse elements 622, 624, and/or 626 having the smallest cross-sectional dimension can have a lowest threshold for electrical current at which it will break. Upon breaking, the current through the remaining ones of the fuse elements 622, 624, and/or 626 can increase. While they can have a higher threshold for electrical current at which they will break, such an increase can approach such a threshold. For example, the first fuse element 622 on a first side 602 of the series busbar 600 can have a first cross-sectional dimension. The second fuse element 624, between the first fuse element 622 and the third fuse element 626, can have a second cross-sectional dimension (e.g., different than and/or greater than the first cross-sectional dimension). The third fuse element 626 on a second side 604 on a second side 604, opposite the first side 602, of the series busbar 600 can have a third cross-sectional dimension (e.g., different than and/or greater than the first cross-sectional dimension and/or the second cross-sectional dimension). The first side 602 can face toward the CCA and/or other components of the battery module. The second side 604 can face away from the CCA and/or other components of the battery module. Accordingly, in the event that the fuse 620 receives excessive electrical current, the first fuse element 622, closest to other components of the battery module, can break first, when the electrical current thereat is relatively lower. The one or more other fuse elements, including the third fuse element 626 that is farthest from the other components of the battery module, can break later, when the electrical current thereat is relatively higher.

In some embodiments, the first terminal 610, the second terminal 612, and the fuse 620 (e.g., the fuse elements 622, 624, and/or 626) are of a conductive material (e.g., aluminum, copper, combinations thereof, and the like). In some embodiments, the first terminal 610, the second terminal 612, and the fuse 620 (e.g., the fuse elements 622, 624, and/or 626) form a monolithic structure.

FIG. 15B illustrates a perspective view of the series busbar of FIG. 15A with an enclosure. As shown in FIG. 15B, the series busbar 600 can include a fuse housing and/or a container 690 for housing and/or surrounding the fuse 620, including the fuse elements 622, 624, and/or 626. The container 690 can be of a non-conductive material (e.g., plastic). In some embodiments, the container 690 is provided as multiple (e.g., two) parts, such as a first container portion 691 and/or a second container portion 695. The first container portion 691 and the second container portion 695 are assembled together on opposing sides of the fuse 620. The first container portion 691 and the second container portion 695 can be secured together, for example by ultrasonic welding and/or the like. In some embodiments, the container 690 encloses a space therein, and an encapsulant is provided at one or more spaces therein. For example, the container 690 can be filled with one or more materials serving as the encapsulant. By further example, the encapsulant can include an amount of an electrically insulative material (e.g., quartz silica sand, other electrically insulative grains, and the like). The encapsulant can fill spaces between the parts of the container 690 and/or the fuse 620. In some embodiments, the container 690 is filled with the encapsulant (e.g., quartz silica sand), and a seal plug is provided thereafter (e.g., by press fitting) to retain the encapsulant therein.

FIG. 16A illustrates a perspective view of a portion of another series busbar 600 of a battery module. As shown in FIG. 16A, the series busbar 600 includes a first terminal 610 and a second terminal 612, which can have one or more features as described with respect to the series busbar 600 of FIGS. 15A and 15B. The series busbar 600 can further include a fuse 620, which can include one or more fuse plates 632. The fuse 620 can connect (e.g., mechanically and electrically), in parallel, the first terminal 610 and the second terminal 612. While two fuse plates 632 are illustrated, it will be understood that any number of fuse plates can be provided. The fuse plates 632 each define one or more fuse elements 636 arranged in one or more columns (e.g., two columns shown in FIG. 16A) and separated from each other by one or more openings 638 each arranged between a respective pair of the fuse elements 636. The openings 638 can form a round (e.g., circular shape) or another shape. Accordingly, the fuse elements 636 can each have a variable cross-sectional dimension along the respective length thereof. The fuse elements 636 provide an ability to break under excessive electrical current, thereby disconnecting the first set of battery cells from the second set of battery cells under certain conditions.

In some embodiments, one or more than one (e.g., two or more) fuse plates 632 are provided between the first terminal 610 and the second terminal 612. In some embodiments, one or more than one (e.g., two or more) columns of fuse elements 636 and/or openings 638 are provided by each fuse plate 632. In some embodiments, the fuse elements 636 and/or openings 638 provide a variable (e.g., curved, round, and/or circular) cross-sectional shape along respective lengths thereof and/or a consistent (non-variable) cross-sectional shape along respective lengths thereof.

In some embodiments, each of the multiple fuse elements 636 has a different cross-sectional dimension from one or more of the other fuse elements 636. As used herein, the cross-sectional dimension can be a width, thickness, height, diameter, and/or other dimension that is defined in a cross-section of the fuse elements 636. One of the fuse elements 636 can have a smallest cross-sectional dimension relative to one or more of the other fuse elements 636. Accordingly, the one of the fuse elements 636 having the smallest cross-sectional dimension can have a lowest threshold for electrical current at which it will break. Upon breaking, the current through the remaining ones of the fuse elements 636 can increase. While they can have a higher threshold for electrical current at which they will break, such an increase can approach such a threshold. For example, the first fuse elements 636 on the first side 602 can be smaller than the fuse elements 636 on the second side 604. Accordingly, in the event that the fuse 620 receives excessive electrical current, the smaller fuse elements 636, closest to other components of the battery module, can break first, when the electrical current thereat is relatively lower. The one or more other fuse elements 636 that are farthest from the other components of the battery module, can break later, when the electrical current thereat is relatively higher. In some embodiments, the fuse elements 636 can have a common cross-sectional dimension (e.g., a minimum cross-sectional dimension).

In some embodiments, the first terminal 610, the second terminal 612, and the fuse 620 (e.g., the fuse plates 632) are of a conductive material (e.g., aluminum, copper, combinations thereof, and the like). In some embodiments, the first terminal 610, the second terminal 612, and the fuse 620 (e.g., the fuse plates 632) are an assembly of separate parts. This can provide an ability to assemble multiple fuse plates 632 in parallel between the first terminal 610 and the second terminal 612.

FIG. 16B illustrates a perspective view of a first container portion 691 of a container for a busbar in accordance with one or more implementations of the present disclosure. In some embodiments, the first container portion 691 includes a first body 692 and one or more engagers 693 (e.g., posts, pins, extensions, and/or the like) extending from the first body 692. For example, each of the engagers 693 can extend, for example, in a common direction. In some embodiments, the engagers 693 can have a same size, shape, and/or other feature. In some embodiments, the first container portion 691 can provide symmetry across one or more axes. The first container portion 691 can provide and/or be provided with an adhesive 694 on one or more surfaces thereof, such as a surface from which the engagers 693 extend.

FIG. 16C illustrates a perspective view of a second container portion 695 of a container for a busbar in accordance with one or more implementations of the present disclosure. In some embodiments, the second container portion 695 includes a second body 696 and one or more openings 697 (e.g., cavities, recesses, holes, and/or the like) extending within the second body 696. For example, each of the openings 697 can extend, for example, in a common direction. In some embodiments, one or more of the openings 697 can have a same size, shape, and/or other feature. In some embodiments, one or more of the openings 697 can have different sizes, shapes, and/or other features. The openings 697 can form 2-way and/or 4-way datums with the engagers 693 of the first container portion 691. For example, one or more of the openings 697 can receive engagers 693 of the first container portion 691 and permit a limited range of motion thereof within the respective opening 697 of the second container portion 695. In some embodiments, the second container portion 695 can provide symmetry across one or more axes. The second container portion 695 can provide and/or be provided with an adhesive 698 on one or more surfaces thereof, such as a surface into which the openings 697 extend.

FIG. 16D illustrates a perspective view of a portion of a busbar with a first portion of a container in accordance with one or more implementations of the present disclosure. In some embodiments, as shown in FIG. 16D, the series busbar 600 (e.g., near or at the fuse 620) can include one or more alignment features 634 for receiving engagers 693 (e.g., posts, pins, extensions, and/or the like) of the first container portion 691. For example, the alignment features 6345 can be formed at or near one or both of the first terminal 610 and the second terminal 612. In some embodiments, the alignment features 634 can include one or more openings. The openings can form 2-way and/or 4-way datums with the engagers 693 of the first container portion 691. For example, one or more of the alignment features 634 can receive engagers 693 of the first container portion 691 and permit a limited range of motion thereof within the respective opening of the alignment features 634.

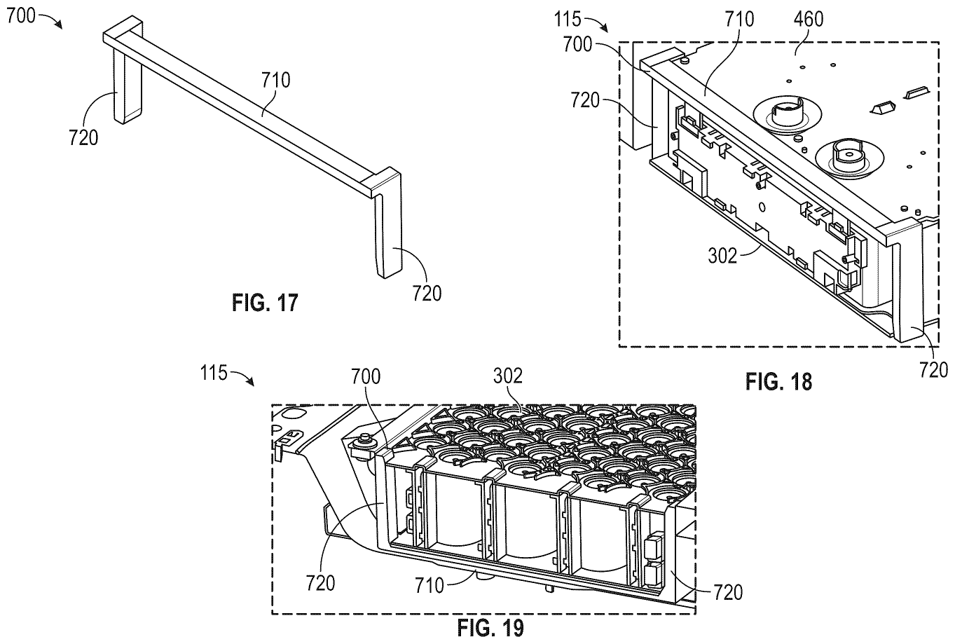

Referring now to FIG. 17-20, a battery module 115 can be provides with features to facilitate and manage potting and to support the components thereof. For example, one or more potting dams can be provided to limit the ingress of potting material.

FIG. 17 illustrates a perspective view of a potting dam of a battery module. As shown in FIG. 17, a potting dam 700 can include a structure that complements the shape of other components of a battery module and that provides sealing against passage of a potting material. In some embodiments, the potting dam 700 includes a lateral structure 710 and one or more longitudinal structures 720. The one or more longitudinal structures 720 can extend transverse to the lateral structure 710. It will be understood that the potting dam 700 can have one or more of a variety of shapes and/or sizes to provides sealing at edges and/or corners of a battery module. The potting dam 700 can be of a flexible, compressible, and/or compliant material, such as a polymer (e.g. neoprene), elastic, and/or foam. The potting dam 700 can be substantially impermeable to a potting material.

FIG. 18 illustrates a perspective view of a portion of a battery module with a potting dam. As shown in FIG. 18, the potting dam 700 can extend at peripheral edges of one or more components of the battery module 115. For example, the lateral structure 710 can extend along an end of the cover 460. The one or more longitudinal structures 720 can extend between the cover 460 and the base 302, for example at terminal ends thereof. It will be understood that the potting dam 700 can include one or more other portions to extend along and/or abuts other components of the battery module 115.

FIG. 19 illustrates a perspective view of a portion of a battery module with a potting dam. As shown in FIG. 19, the battery module 115 can be provided in a configuration for receiving a potting material. For example, the battery module 115 can be provided in an inverted orientation relative to the orientation shown in FIG. 18. In such a configuration, the lateral structure 710 of the potting dam 700 can extend horizontally along a bottommost portion at a terminal end of the battery module 115. Additionally, in such a configuration, the longitudinal structures 720 of the potting dam 700 can extend vertically along edges and corners of the battery module 115. Furthermore, in such a configuration, the battery module 115 is prepared to receive potting material, for example as a fluid to be cured into a solid. Accordingly, the potting dam 700 can help maintain the potting material within the boundaries defined by the periphery of the battery module 115.

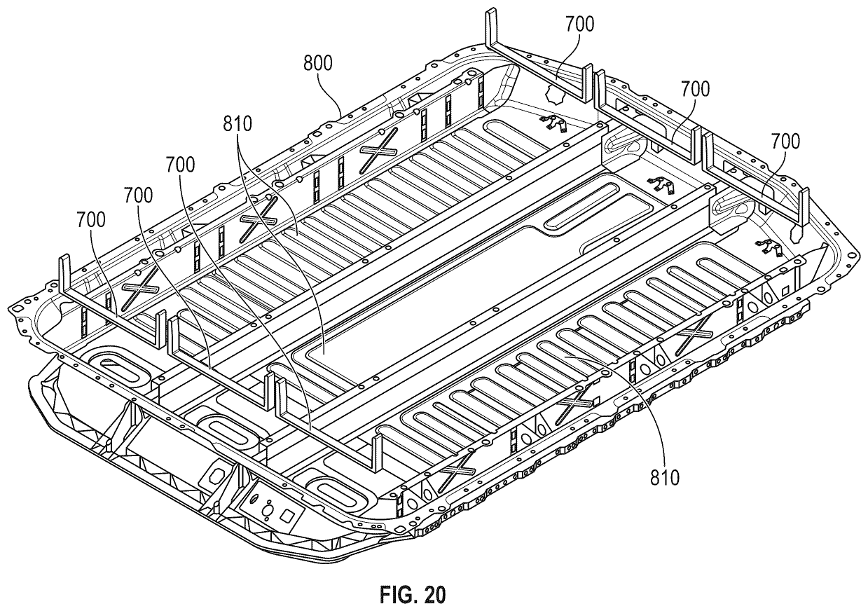

FIG. 20 illustrates a perspective view of a portion of a battery module with multiple potting dams. As shown in FIG. 20, a carriage 800 can support multiple battery modules (not shown) between opposing pairs of the potting dams 700. For example, the carriage 800 can include multiple bays 810, each for receiving a corresponding one of multiple battery modules. The battery modules can be provided between opposing pairs of the potting dams 700, and a potting material can be provided to the battery modules and/or within the multiple bays 810 of the carriage 800. Accordingly, the potting dam 700 can retain the potting material within the bays 810.

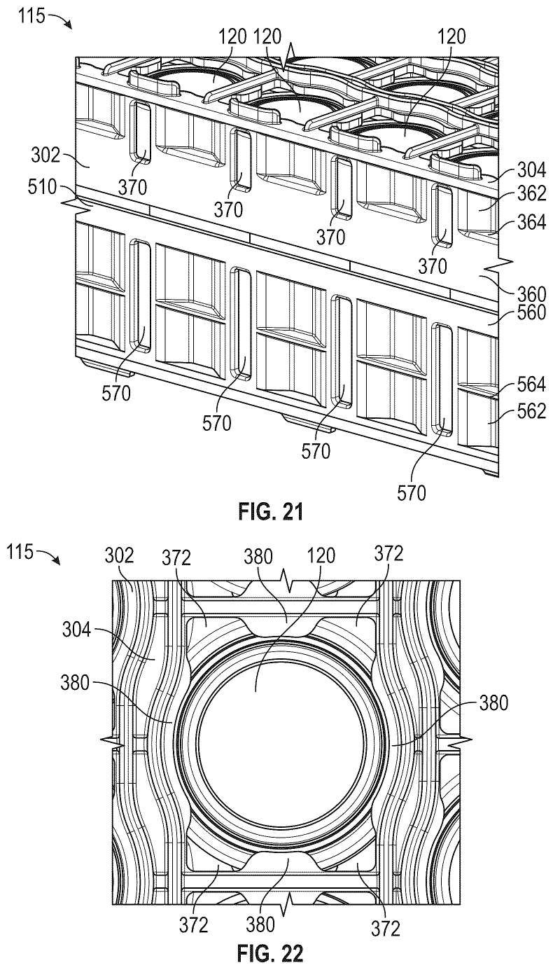

Referring now to FIGS. 21 and 22, a battery module 115 can provide features to facilitate potting and to support the components thereof. For example, openings in a base and/or a frame facilitate ingress of potting material throughout the assembly as well as venting during a thermal event.

FIG. 21 illustrates a perspective view of a portion of a battery module 115 with a base 302 and a frame containing battery cells 120 in accordance with one or more implementations of the present disclosure. FIG. 22 illustrates a bottom view of a portion of a battery module 115 with a base 302 supporting a battery cell 120 in accordance with one or more implementations of the present disclosure.

As shown in FIG. 21, a battery module 115 can include a base 302 and a frame 510 (and/or frame(s) 512 and/or 514, not shown). The base 302 can include a base plate 304 defining multiple base plate openings 372. Each of the multiple base plate openings 372 can extend through the base plate 304 to provide access to a first side of a respective one of multiple battery cells 120. The base 302 can further include base walls 360 extending from an inner side of the base plate 304 at opposing edges of the base plate 304. Each of the base walls 360 can define multiple base wall openings 370 each extending through a respective one of the base walls 360. In some embodiments, each of the base wall openings 370 is arranged across from a respective one of the base plate openings 372. In some embodiments, the base walls 360 further define multiple base recesses 362 facing away from each other and base ledges 364 configured to face away from the frame. The multiple base recesses 362 can facilitate engagement by a carrying tool or other item that acts upon the base 302 (e.g., for moving and/or rotating the battery module 115).

The frame 510 can include a frame plate defining multiple frame openings 550. Each of the multiple frame openings 550 can extend through the frame plate to provide access to a second side of the respective one of the multiple battery cells 120. The frame 510 can further include frame walls 560 extending from an inner side of the frame plate at opposing edges of the frame plate. Each of the frame walls 560 can define multiple frame wall openings 570 each extending through a respective one of the frame walls 560. The base plate openings 372, the base wall openings 370, and the frame wall openings 570 provide flow paths for a potting material to pass alongside the multiple battery cells 120 to an exterior of the battery subassembly. In some embodiments, each of the frame wall openings 570 is arranged across from a respective one of the frame plate openings (not shown). In some embodiments, the base walls 360 further define multiple frame recesses 562 facing away from each other and frame ledges 564 configured to face away from the base 302. The multiple frame recesses 562 can facilitate engagement by a carrying tool or other item that acts upon the frame 510 (e.g., for moving the assembly).

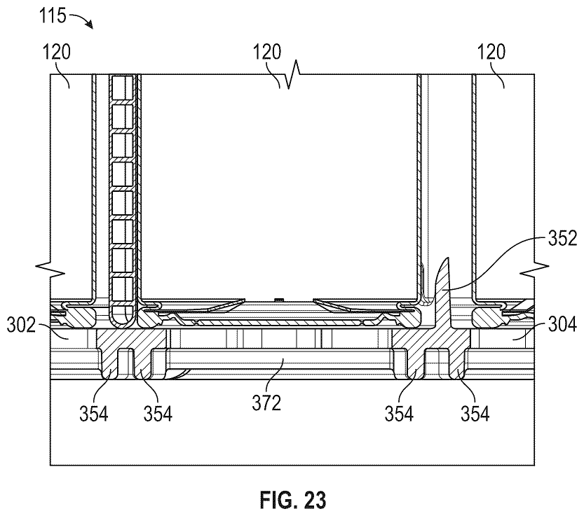

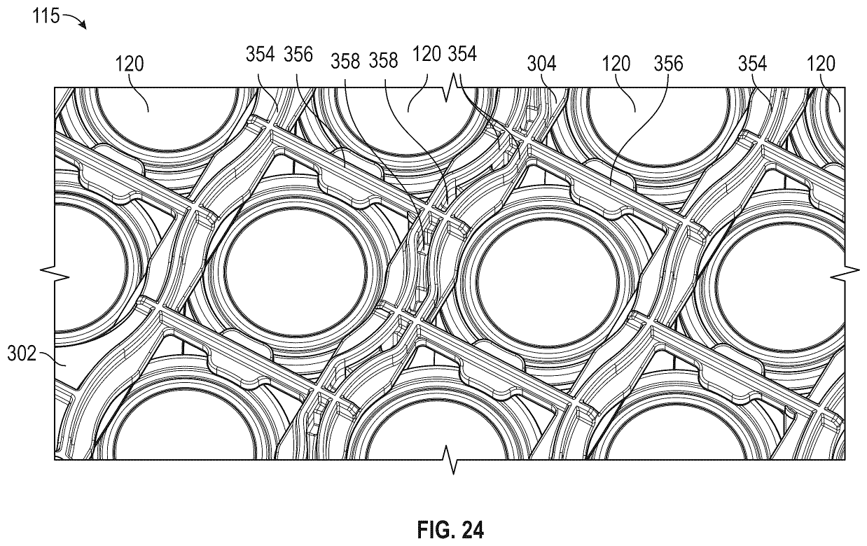

Referring now to FIG. 22-24, in some embodiments, the assembly includes support structures that separate rows of battery cells from each other and provide resistance against bending. FIG. 23 illustrates a sectional view of a portion of a battery module 115 with a base 302 supporting a battery cell 120 in accordance with one or more implementations of the present disclosure. FIG. 24 illustrates a perspective view of a portion of a battery module 115 with a base 302 supporting battery cells 120 in accordance with one or more implementations of the present disclosure.

As shown in FIG. 22-24, a base 302 for a battery module 115 can include a plate 304 defining rows of multiple openings 372, each of the multiple openings 372 extending through the plate 304. The base 302 can include protrusions 380 of the plate 304 each extend radially inwardly into a respective one of the multiple openings 372 for supporting a respective one of multiple battery cells 120. A maximum cross-sectional dimension across each of the multiple openings 372 is greater than a maximum cross-sectional dimension of a respective one of the battery cells 120. A minimum cross-sectional dimension across each of the multiple openings 372, defined by at least one of the protrusions 380, is less than the maximum cross-sectional dimension of the respective one of the battery cells 120.

As shown in FIG. 23, the base 302 can further include inner beams 352 each extending from an inner side of the plate 304 and between a respective pair of rows of the multiple battery cells 120. The base 302 can further include outer beams 354 each extending from an outer side of the plate 304 between a respective pair of the rows of the multiple openings. In some embodiments, a number of the outer beams 354 is greater than a number of the inner beams 352. In some embodiments, each of the inner beams 352 is aligned with a respective one of the outer beams 354. In some embodiments, the outer beams 354 include at least two outer beams 354 extending between a given pair of the rows of the multiple openings. In some embodiments, the outer beams 354 have a first height that is less than a second height of the inner beams 352.

As shown in FIG. 24, different types of openings can be provided. For example, frame plate openings 372 can be provided, and the plate 304 can further define additional openings 358 extending between the at least two outer beams 354 and providing fluid communication between the inner side of the plate 304 and the outer side of the plate 304. As further shown in FIG. 24, different types of openings can be provided. For example, the outer beams can be first outer beams 354, and the base 302 can further include second outer beams 356 extending across one or more of the rows of the multiple openings to connect multiple ones of the first outer beams 354.

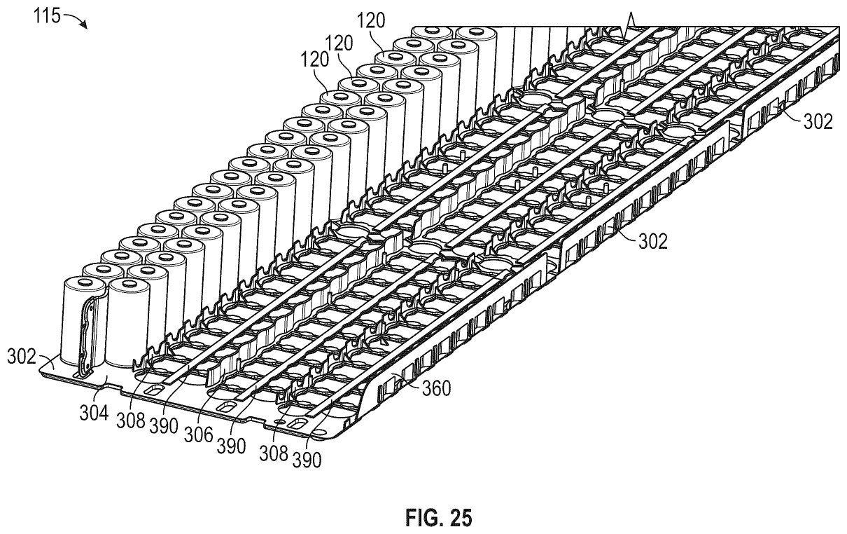

Referring now to FIG. 25, the base can provide one or more features for securing battery cells thereto. FIG. 25 illustrates a perspective view of a portion of a battery module 115 with a base 302 supporting battery cells 120 in accordance with one or more implementations of the present disclosure. As shown in FIG. 25, a base 302 of a battery module 115 can include an adhesive strip 390 (e.g., of or including a pressure-sensitive adhesive) to couple the battery cells 120 to the base 302 along opposing edges of adjacent rows. The strip 390 can be arranged to contact only certain sides of battery cells 120 in different rows. For example, the adhesive strip 390 can be placed in contact with first sides of battery cells 120 arranged in a first row and a second row when the battery cells 120 are provided to the base 302. Accordingly, the strip 390 can extend along an inner side of the base 302 such that the adhesive strip 390 is coupled to opposing portions of the battery cells 120 of the first row and the second row. Thereafter, one or more frames can be provided as abutting second sides of the battery cells 120, the second sides of the battery cells 120 being opposite the first sides of the battery cells 120. A current collector assembly 400 can be provided on the second sides of the battery cells 120. One or more potting dams can each extend along a respective end of the frame to the base 302. Potting material can then be provided between the frame and the base 302.

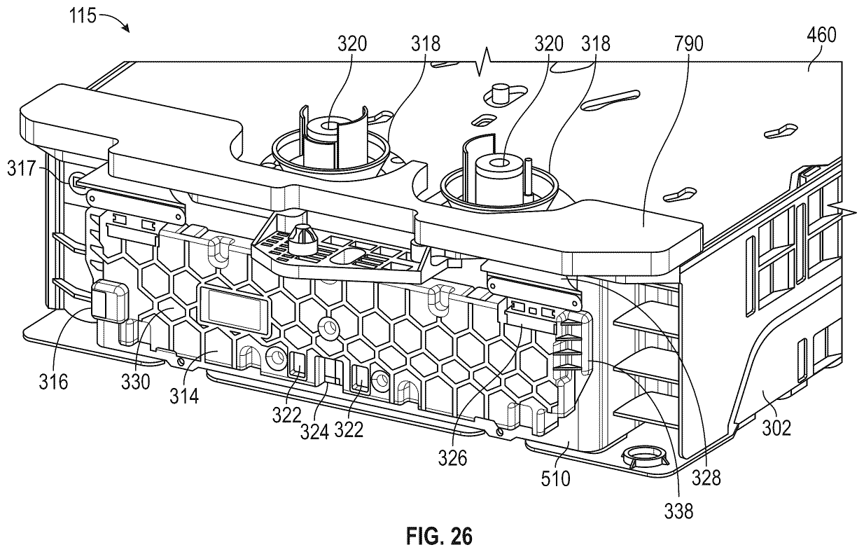

FIG. 26 illustrates a perspective view of a portion of a battery module 115 with a balancing voltage and temperature (“BVT”) module in accordance with one or more implementations of the present disclosure. In some embodiments, a BVT module 314 is provided at an end of the battery module 115. The BVT module 314 communicatively couples to one or more temperature sensors, such as a thermistor assembly 316 and/or 317. The BVT module 314 may take the form a modular assembly of various electrical components to monitor and/or control components of the battery module 115. For example, the BVT module 314 may include a circuit board 338 that is attached to a housing 330 of the BVT module 314. The BVT module 314 may include various connectors to couple with, for example, a thermistor, a voltage sensor assembly 328, and/or a communication device, as non-limiting examples. The voltage sensor assembly 328 can include a harness 326 for connecting to the BVT module 314. The voltage sensor or balancer may sense or control voltage that flows through the battery module 115 and/or one or more battery cells 120 thereof. The communication device may receive, transmit, or analyze data associated with the battery module 115 and/or a battery cell 120 thereof. In some embodiments, the BVT module 314 can include one or more connectors 324 and/or one or more test pads 322 for testing and/or connection to other devices. As further shown in FIG. 26, the battery module 115 can include one or more busbars 320 for connecting to one or more other devices and/or components. The one or more busbars 320 can include and/or define terminals for providing electrical power to another device and/or component. The busbars 320 can each be provided with a seal 318 or other barrier surrounding portions thereof.

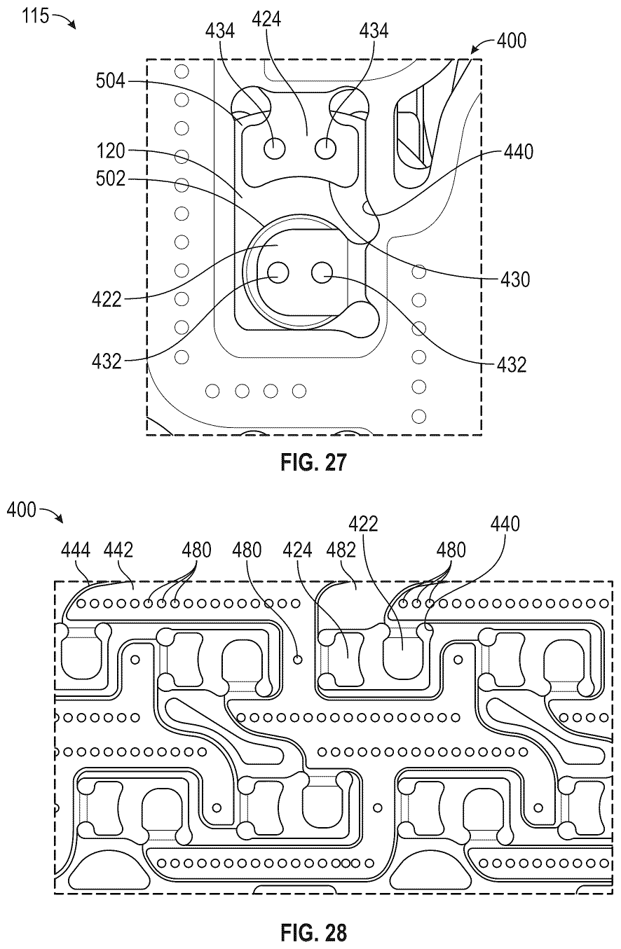

Referring now to FIG. 27-33, a current collector assembly (CCA) can be provided to engage one or more battery cells. FIG. 27 illustrates a top view of a portion of a battery module 115 with a current collector assembly 400 connected to a battery cell 120 in accordance with one or more implementations of the present disclosure. As shown in FIG. 27, the CCA 400 has a weld tab geometry that provides a degree of overlap with a respective terminal of the battery cell 120.

As shown in FIG. 27, the battery module 115 is assembled by providing a current collector assembly 400 to one or more battery cells 120. Each of the one or more battery cells 120 includes a central portion 502 defining a first terminal and a peripheral rim 504 defining a second terminal. In some embodiments, a battery module 115 can include one or more battery cells 120 each including a central portion 502 defining a first terminal and a peripheral rim 504 defining a second terminal. The current collector assembly 400 can include one or more first interconnect portions 422 and one or more second interconnect portions 424. The one or more first interconnect portions 422 can each be welded to a respective central portion 502 of a respective one of the one or more battery cells 120. The one or more second interconnect portions 424 can each be welded to a respective peripheral rim 504 of the respective one of the one or more battery cells 120.

In some embodiments, each of one or more first interconnect portions 422 of the current collector assembly 400 is welded to a respective central portion 502 of a respective one of the one or more battery cells with one or more first weld regions 432. In some embodiments, each of one or more second interconnect portions 424 of the current collector assembly 400 is welded to a respective peripheral rim 504 of the respective one of the one or more battery cells 120 with one or more second weld regions 434.

In some embodiments, each of the one or more second interconnect portions 424 terminates in a respective concave edge 430 that extends along a concave shape of the respective peripheral rim 504 of the respective one of the one or more battery cells 120. In some embodiments, the respective concave edge 430 of each of the one or more second interconnect portions 424 is positioned such that multiple portions along the respective concave edge 430 are a common distance away from the respective central portion 502 of the respective one of the one or more battery cells 120. As such, the distance between the concave edge 430 and the central portion 502 can be maintained at an approximately constant distance across various portions thereof. The distance can be selected to minimize and/or avoid dielectric breakdown between the concave edge 430 and the central portion 502.

FIG. 28 illustrates a top view of a portion of a current collector assembly 400 in accordance with one or more implementations of the present disclosure. As shown in FIG. 28, the current collector assembly 400 can include a first conductor 442 and a second conductor 444. The first conductor 442 can have one or more portions that terminate adjacent to each of the one or more first interconnect portions 422. For example, the second conductor 444 can define ends (e.g., terminal ends) that terminate at a location from which a respective interconnect portion extends into an opening 440 of the CCA 400. The second conductor 444 can overlap with the first conductor 442 and define at least a portion of each of the one or more first interconnect portions 422.

In some embodiments, the first conductor 442 is welded to the second conductor 444 at one or more CCA weld regions 480. In some embodiments, the one or more CCA weld regions 480 extend in one or more rows along one or more portions of the first conductor 442. In some embodiments, each of the one or more first interconnect portions 422 extends from a respective one of the one or more portions of the first conductor 442.

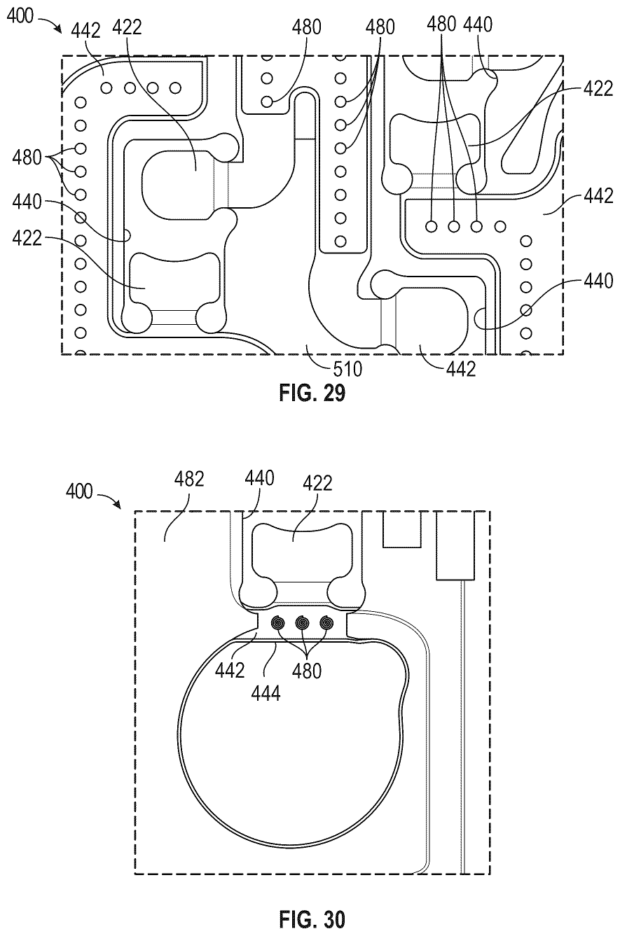

FIG. 29 illustrates a top view of a portion of a current collector assembly 400 with enlarged views of interconnect portions 422 and 424 in accordance with one or more implementations of the present disclosure. In some embodiments, each of the interconnect portions 422 and/or 424 extend into an opening 440 of the CCA 400. For example, a pair of a interconnect portions 422 and an interconnect portion 424 can extend into a common opening 440.

FIG. 30 illustrates a top view of a portion of a current collector assembly 400 in accordance with one or more implementations of the present disclosure. In some embodiments, each of the one or more first interconnect portions 422 (e.g., defined as a portion of the first conductor 442) extends from a respective portion of the second conductor 444 that includes one or more CCA weld regions 480. For example, as shown in FIG. 30, the first interconnect portion 422 can be defined as a portion of the first conductor 442 extending into an opening 440 of the CCA 400. The first interconnect portion 422 can extend from a portion of the second conductor 444 at which multiple (e.g., three) CCA weld regions 480 are provided to couple the first conductor 442 to the second conductor 444. This can provided enhanced securement of the first conductor 442 to the second conductor 444 at a location at which additional forces may be applied (e.g., via the first interconnect portion 422).

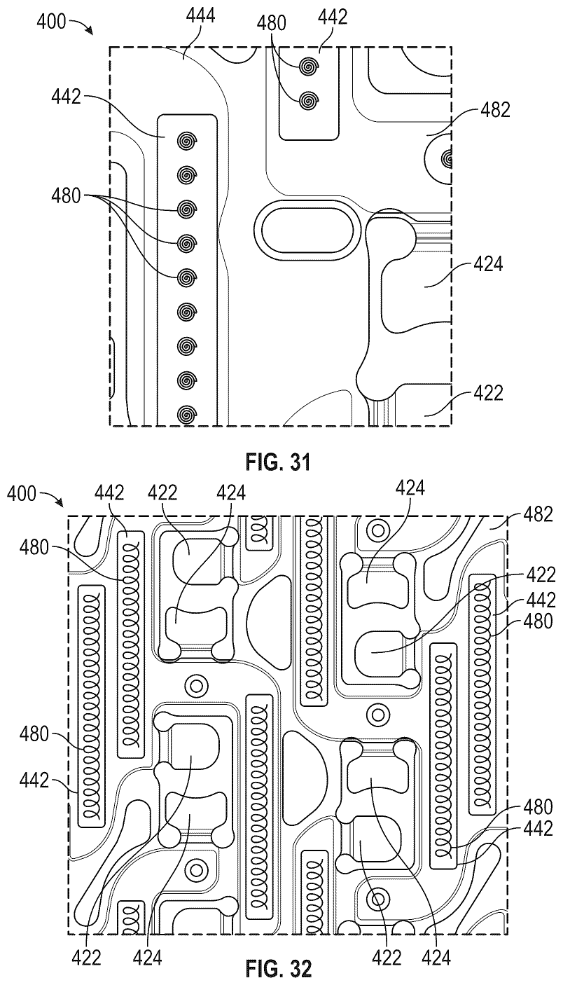

Referring now to FIGS. 31-33, CCA welds can be provided in one or more of a variety of shapes to provided secure coupling between layers of conductors.

FIG. 31 illustrates a top view of a portion of a current collector assembly 400 in accordance with one or more implementations of the present disclosure. In some embodiments, as shown in FIG. 31, each of the one or more CCA weld regions 480 defines a spiral shape. Such a shape can provide redundant securement within a region (e.g., via multiple turns of the spiral) while avoiding excessive application of energy during the welding process. For example, a spiral can be provided with gradual turns (e.g., no corners) while not crossing its own path. As such, the application of energy can be consistent across the length to provide a consistent weld depth.

FIG. 32 illustrates a top view of a portion of a current collector assembly 400 in accordance with one or more implementations of the present disclosure. In some embodiments, as shown in FIG. 32, each of the one or more CCA weld regions 480 defines (and/or is part of) a continuous series of multiple loops extending along a length of the first conductor 442. Such a shape can provide redundant securement within a region (e.g., via multiple loops) while avoiding excessive application of energy during the welding process. For example, the loops can be provided with gradual turns (e.g., no corners). The loops may cross their own paths but may be spaced apart such that the previously welded region can cool sufficiently before crossing occurs. As such, the application of energy can be consistent across the length to provide a consistent weld depth. The continuous aspect of the multiple loops provides continuous securement across a length thereof.

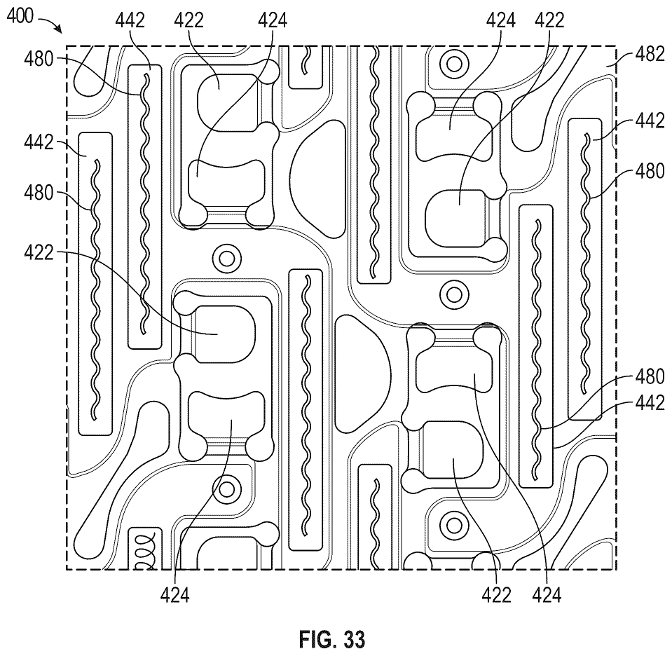

FIG. 33 illustrates a top view of a portion of a current collector assembly 400 in accordance with one or more implementations of the present disclosure. In some embodiments, as shown in FIG. 33, each of the one or more CCA weld regions 480 defines (and/or is part of) an undulating shape extending along a length of the first conductor 442. Such a shape can provide redundant securement within a region (e.g., via multiple waves) while avoiding excessive application of energy during the welding process. For example, the loops can be provided with gradual turns (e.g., no corners) while not crossing its own path. As such, the application of energy can be consistent across the length to provide a consistent weld depth. The continuous aspect of the undulating shape (e.g., with multiple waves) provide continuous securement across a length thereof.

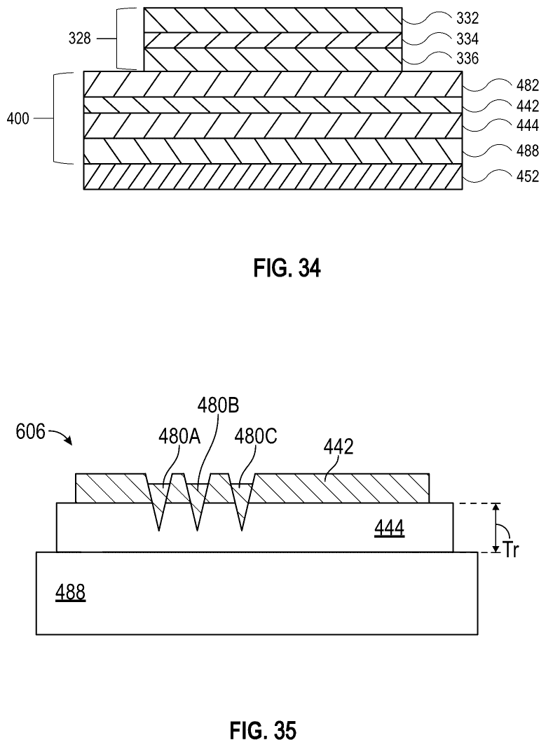

Referring now to FIGS. 34 and 35, layers of a current collector assembly can be welded together to provide securement and electrical conductivity thereat. FIG. 34 illustrates a sectional view of a portion of a current collector assembly 400 and a voltage sensor assembly 328 in accordance with one or more implementations of the present disclosure. As shown in FIG. 34, the CCA 400 can include multiple layers, including one or more layers of conductors (e.g., the first conductor 442 and/or the second conductor 444) and one or more layers of coverlays (e.g., a top coverlay 482 and/or a bottom coverlay 488). The first conductor 442 and/or the second conductor 444 can include an electrically conductive material (e.g., aluminum, copper, nickel, and/or combinations thereof). The top coverlay 482 and/or the bottom coverlay 488 can include an electrically insulative material (e.g., PET, another polymer, and/or combinations thereof). The top coverlay 482 and the bottom coverlay 488 can surround the first conductor 442 and/or the second conductor 444 at various regions of the CCA 400 to provide electrical isolation thereof.

By providing the first conductor 442 and the second conductor 444 in separate layers, an effective welding process is facilitated. In some embodiments, the first conductor 442 can be thinner (e.g., have lower thickness) than the second conductor 444. Such relative dimensions can allow a relatively thinner layer (e.g., the first conductor 442) to fuse, melt, and/or weld into a relatively thicker layer (e.g., the second conductor 444). The combined thickness of the first conductor 442 and the second conductor 444 can provide adequate electrical conduction. The second conductor 444 can provide continuity into the interconnect portions 422 and/or 424, such that portions of the second conductor 444 form the interconnect portions 422 and/or 424. The interconnect portions 422 and/or 424 are thereafter welded to the battery cells, as described herein. Accordingly, the second conductor 444 provides the material to fuse, melt, and/or weld into the corresponding portions (e.g., central portions and/or peripheral rims) of the battery cells.

As further shown in FIG. 34, the voltage sensor assembly 328 can include multiple layers, including one or more layers of conductors (e.g., the VS conductor 334) and one or more layers of coverlays (e.g., a top VS coverlay 332 and/or a bottom VS coverlay 336). It should be understood that the voltage sensor assembly 328 may extend across only a portion of the CCA 400. The VS conductor 334 can include an electrically conductive material (e.g., aluminum, copper, nickel, and/or combinations thereof). The top VS coverlay 332 and/or a bottom VS coverlay 336 can include an electrically insulative material (e.g., PET, another polymer, and/or combinations thereof). The top VS coverlay 332 and/or a bottom VS coverlay 336 can surround the VS conductor 334 at various regions of the voltage sensor assembly 328 to provide electrical isolation thereof.

As further shown in FIG. 34, a layer of an adhesive 452 is provided for adhering the CCA 400 to a frame (not shown). The adhesive 452 can include a pressure-sensitive adhesive. The CCA 400 (e.g., at the bottom coverlay 488) can be securely adhered to the frame upon application of a pressure or force (e.g. pressing). Such adhesion can be effected following alignment of the CCA 400 with respect to the frame, as described further herein. Accordingly, the adhesive 452 can secure the CCA 400 to the frame, and welds at the interconnect portions can secure the CCA 400 to the battery cells.

FIG. 35 illustrates a sectional view of a portion of a CCA 400 in accordance with one or more implementations of the present disclosure. As shown in FIG. 35, the second conductor 444 may have a thickness, Tr. For example, in one or more implementations, the thickness, Tr, may be between 0.2 mm and 0.8 mm (e.g., 0.5 mm). By further example, in one or more implementations, the thickness of the first conductor 442 may be between 0.1 mm and 0.7 mm (e.g., 0.3 mm). As shown, a depth of the CCA welds 480 to the second conductor 444 can be within the thickness, Tr, of the second conductor 444. For example, in a process for welding the first conductor 442 to the second conductor 444, the CCA weld(s) 480 can be allowed to penetrate, in some instances, to and/or entirely through the second conductor 444 (e.g., with or without extending to another substrate, such as the bottom coverlay 488). In the example of FIG. 35, the CCA weld 480 that connects the first conductor 442 to the second conductor 444 includes multiple weld portions 480A, 480B, and 480C, which can represent portions of a continuous weld. For example, the multiple weld portions 480A, 480B, and 480C can represent multiple turns of a spiral shape, multiple loops of a continuous shape, and/or multiple waves of an undulating shape.

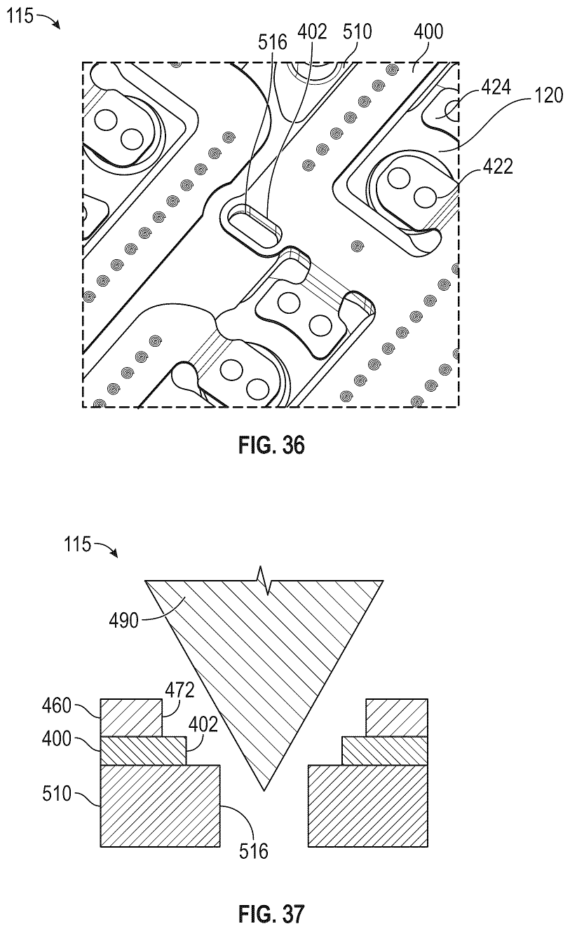

Referring now to FIGS. 36 and 37, an alignment tool and procedure can be provided to align multiple components of a battery assembly. In some embodiments, the alignment features can provide interactions with an alignment tool that need not be a part of the resulting battery module. The layers of the subassembly also include locating datum features for alignment.

FIG. 36 illustrates a perspective view of a portion of a battery module 115 including a current collector assembly 400 and a frame 510 layered on top of one another and above battery cells 120 in accordance with one or more implementations of the present disclosure. In some embodiments, as shown in FIG. 36, the battery module 115 includes a current collector assembly 400 and/or a frame 510 (and/or frame(s) 512 and/or 514, not shown). The current collector assembly 400 can be positioned beneath a cover (not shown) and include interconnect portions 422 and/or 424 for electrically connecting to terminals and/or of one or more battery cells 120. The current collector assembly 400 can define a CCA opening 402 extending through the current collector assembly 400 and forming the shape with a second size smaller than a first size (e.g., of the cover). The frame 510 can define a frame opening 516 extending through the frame and forming the shape with a third size smaller than the second size. The current collector assembly 400 can be connected to the one or more battery cells 120 through additional frame openings in the frame 510.

FIG. 37 illustrates a sectional view of a portion of a battery module 115 with a cover 460, a current collector assembly 300, and a frame 510 that are aligned with a tapered tool in accordance with one or more implementations of the present disclosure. As shown in FIG. 37, the cover opening, the CCA opening, and the frame opening can be concentrically aligned. The cover 460 can overlap the current collector assembly 400, which can overlap the frame 510. In some embodiments, the cover 460 can define a cover opening 472 extending through the cover 460 and forming a shape with a first size. For example, the CCA opening 402 of the current collector assembly 400 can be aligned to be concentric with the frame opening 516 of the frame 510 between the current collector assembly 400 and the one or more battery cells. By further example, the cover opening 472 of the cover 460 can be aligned to be concentric with the CCA opening of the current collector assembly 400. Such an alignment can be performed in sequence or simultaneously. For example, an alignment tool 490 can be provided. The alignment tool 490 can have a tapered or other shape that engages each of the cover opening 472 of the cover 460, the CCA opening 402 of the current collector assembly 400, and the frame opening 516 of the frame 510. Based on the respective shapes and/or sizes of the cover opening 472, the CCA opening 402, and the frame opening 516, the alignment tool 490 can urge each of the corresponding structures to be concentric with each other. For example, the cover opening 472, the CCA opening 402, and the frame opening 516 can have the same or similar shapes of varying sizes (e.g., progressively increasing or decreasing in a direction of the stack). As such, the alignment tool 490 can urge the cover 460, the current collector assembly 400, and the frame 510 into alignment with each other.

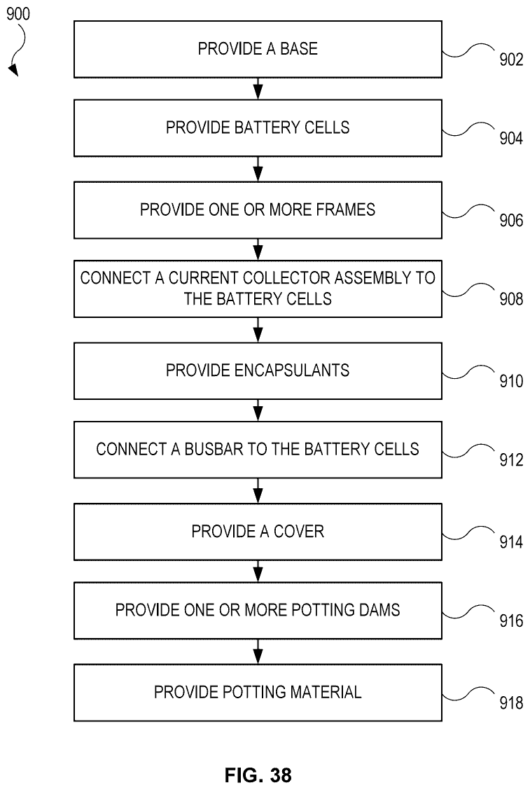

FIG. 38 illustrates a flow diagram showing an example of a process 900 that may be performed for forming a battery module in accordance with one or more implementations of the present disclosure. For explanatory purposes, the process 900 is primarily described herein with reference to components illustrated in FIG. 4-37. However, the process 900 is not limited to the components illustrated in FIG. 4-37, and one or more blocks (or operations) of the process 900 may be performed with one or more other components of other suitable apparatuses, devices, or systems. Further for explanatory purposes, some of the blocks of the process 900 are described herein as occurring in serial, or linearly. However, multiple blocks of the process 900 may occur in parallel. In addition, the blocks of the process 900 need not be performed in the order shown and/or one or more blocks of the process 900 need not be performed and/or can be replaced by other operations.

At block 902, a base is provided. The base can be configured and arranged to support one or more battery cells, including one or more such a battery cells.

At block 904, one or more battery cells and/or sets of battery cells is provided. For example, the battery cells and/or sets of battery cells can be provided to the base. Sets of the battery cells can be arranged to contact a cooling element (e.g., an intercellular cooling tube).

For example, the battery cells can be separated by the cooling element. The arrangement of cells in contact with a cooling element (e.g., an intercellular cooling tube) can be referred to as a grapevine or a grapevine assembly.

At block 906, one or more frames is provided. For example, the one or more frames can be provided extending over one or more battery cells and/or such as battery cells.

At block 908, a current collector assembly is connected to each of one or more battery cells. For example, the current collector assembly can be provided on top of the one or more frames, and portions of the current collector assembly can extend through the frame to connect to terminals of the battery cells.

At block 910, one or more encapsulants can be provided. For example, each of the encapsulants can cover a portion of the frame, a portion of a battery cell (e.g., terminals), and a portion of the current collector assembly (e.g., interconnect portions).

At block 912, a busbar is connected to one or more of the battery cells and/or sets of the battery cells. For example, the busbar can be provided on top of a portion of one or more frames. By further example, the busbar can connect a first set of battery cells on a first side of a cooling element to a second side of battery cells on a second side of the cooling element.

At block 914, a cover is provided. For example, the cover can be provided on top of at least a portion of the one or more frames, the current collector assembly, and/or the encapsulants.

At block 916, one or more potting dams is provided. For example, a potting dam can be provided at each end of a portion of the battery module.

At block 918, a potting material is provided. For example, the potting material can be provided to infiltrate into and/or between one or more components of the battery module. The one or more potting dams can retain the potting material within a region of the battery module.

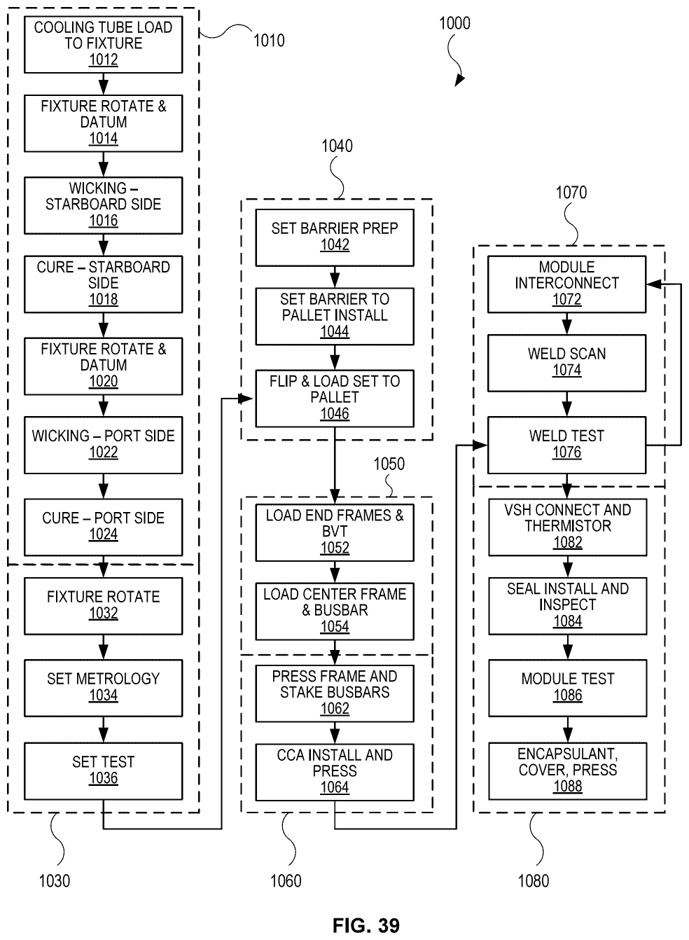

In accordance with one or more implementations of the present disclosure, a process is provided for assembling a battery module. In accordance with one or more implementations of the present disclosure, a facility is provided in which a battery module is assembled. FIG. 39 illustrates a flow diagram showing an example of a process that may be performed for assembling a battery module in accordance with one or more implementations of the present disclosure. For explanatory purposes, the process is primarily described herein with reference to components illustrated in FIG. 4-37. However, the process 1000 is not limited to the components illustrated in FIG. 4-37, and one or more blocks (or operations) of the process may be performed with one or more other components of other suitable apparatuses, devices, or systems. Further for explanatory purposes, some of the blocks of the process are described herein as occurring in serial, or linearly. However, multiple blocks of the process may occur in parallel. In addition, the blocks of the process need not be performed in the order shown and/or one or more blocks of the process need not be performed and/or can be replaced by other operations.

In a first stage 1010 (e.g., a battery cell set assembly stage), and at block 1012, a set of battery cells can be arranged in a predetermined arrangement and/or pattern (e.g., a “grapevine”), including one or more rows and/or columns, for example so as to contact a thermal management element or member such as a cooling member or element. At block 1014, battery cells (e.g., at a cooling tube positioned between cells) can be loaded to a fixture (and/or adjacent to a cooling element). At block 1014, the fixture can be rotated (e.g., in a first direction) to facilitate alignment of the battery cells, for example, with one or more datums and/or with the force of gravity (with the battery cells against a first side of the cooling element). At blocks 1016 and 1018, a first (e.g., starboard) side of the arrangement of the battery cells can be wicked (e.g., of adhesive or other material to attach cells to a cooling tube) and allowed to cure. At block 1020, the fixture can be rotated (e.g., in a second direction) to facilitate alignment of the battery cells, for example, with one or more datums and/or with the force of gravity (with the battery cells against a second side of the cooling element). At blocks 1022 and 1024, a second (e.g., port) side of the arrangement of the battery cells can be wicked (e.g., of adhesive or other material) and allowed to cure.

In a second stage 1030 (e.g., a battery cell set inspection stage), a set of battery cells can be inspected. At blocks 1032, 1034, and 1036, such inspection can include rotation of the fixture (and/or the arrangement of battery cells), measurement (e.g., with one or more metrics), and/or high potential testing to assess the dielectric strength of an insulation of the battery cells.

In a third stage 1040 (e.g., a battery cell set unloading stage), at blocks 1042, 1044, and 1046, the arrangement of the battery cells can be provided to a pallet that has been prepared with a barrier and arranged with respect to the arrangement of the battery cells.

In a fourth stage 1050 (e.g., a frame assembly stage), the set of battery cells can be provided to a base, as described herein, and, at block 1052, a first one or more frames (e.g., a rear frame and/or a front frame) can be provided, along with a balancing voltage and temperature (BVT) module. At block 1054, another frame (e.g., a center frame) can be provided along with one or more busbars.

In a fifth stage 1060 (e.g., a heat stake and CCA installation stage), and at block 1062, the one or more frames can be pressed. Such an action can facilitate adhesion, for example by a pressure sensitive adhesive. At block 1062, the one or more busbars can be heat staked to provide electrical and mechanical connection with the battery cells. At block 1064, a current collector assembly can be installed and pressed onto the one or more frames and aligned with the battery cells.

In a sixth stage 1070 (e.g., an interconnect and testing stage), and at block 1072, the interconnect portions of the current collector assembly can be electrically and mechanically connected to the battery cells, for example by welding. At block 1074, the welds can be optically scanned or otherwise evaluated (e.g., without contact) for quality of connection. At block 1076, the welds can be mechanically evaluated (e.g., with contact) for quality of connection. From block 1076, if one or more welds is not satisfactory, then connection (e.g., by welding) can be repeated or corrected.

In a seventh stage 1080 (e.g., an end-of-line (“EOL”), encapsulant, and cover installation stage), one or more components can be connected, for example, to the BVT module. At block 1082, such installed components can include a thermistor, a voltage sensor, and/or a communication device. At block 1084, one or more seals can be installed, and inspection can be performed. At block 1086, one or more tests can be performed on the battery module. At block 1088, one or more encapsulants can be dispensed onto one or more respective interconnects and/or battery cells, as described herein. At block 1088, a cover can be provided over the encapsulants and pressed thereon.

In a subsequent stage, the battery module can be rotated and/or flipped in preparation for placement in a carriage and for potting therein.

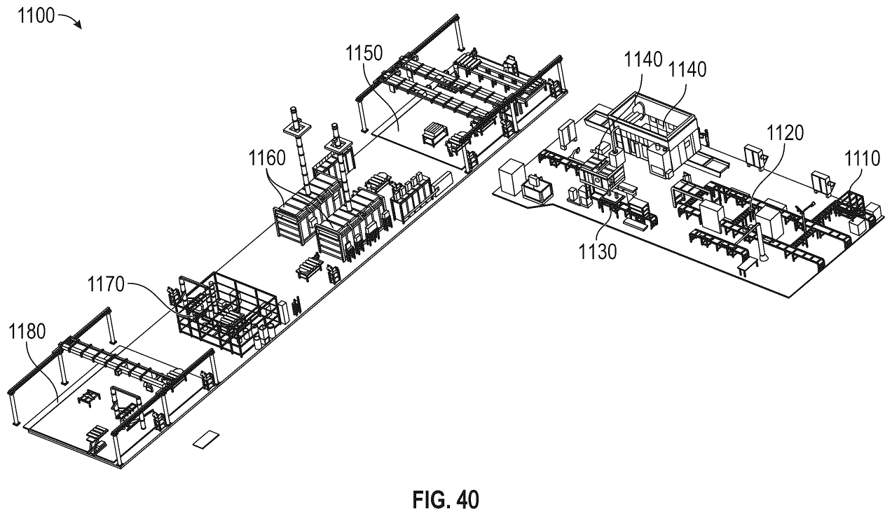

FIG. 40 illustrates a perspective view of a facility for assembling a battery module in accordance with one or more implementations of the present disclosure. The facility can provide stations for performing the operations described herein. For example, as shown in the right side of FIG. 40, one or more stations can be provided to assemble a battery module as described herein. By further example, as shown in the left side of FIG. 40, one or more stations can be provided to assemble each battery module into a battery pack as described herein.

In some embodiments, at a first station 1110 (e.g., a cell processing station) and/or a second station 1120 (e.g., a set of battery cells assembly station), one or more stages of assembly as described with respect to FIG. 39 can be performed, such as the first stage 1010 (e.g., a battery cell set assembly stage), the second stage 1030 (e.g., a battery cell set inspection stage), and/or the third stage 1040 (e.g., a battery cell set unloading stage) of process 1000 as illustrated in FIG. 39.

In some embodiments, at a third station 1130 (e.g., a module assembly station), one or more stages of assembly as described with respect to FIG. 39 can be performed, such as the fourth stage 1050 (e.g., a frame assembly stage) and/or the fifth stage 1060 (e.g., a heat stake and CCA installation stage) of process 1000 as illustrated in FIG. 39.

In some embodiments, at a fourth station 1140 (e.g., a laser weld station), one or more stages of assembly as described with respect to FIG. 39 can be performed, such as the sixth stage 1070 (e.g., an interconnect and testing stage) of process 1000 as illustrated in FIG. 39.

In some embodiments, at a fifth station 1150 (e.g., a high voltage distribution box assembly station), one or more stages of assembly as described with respect to FIG. 39 can be performed, such as at least a portion of the seventh stage 1080 (e.g., an end-of-line (“EOL”), encapsulant, and cover installation stage). For example, a high voltage distribution box (“HVDB”) can be installed. A high voltage distribution box is a component in electric vehicles that manages and distributes high-voltage electrical power from the battery to various systems and components within the vehicle. It can ensure the safe and efficient distribution of power, often incorporating safety features such as fuses and relays to protect the vehicle's electrical system. By further example, an energy management module (“EMM”) can be installed. An energy management module is a system or device that can optimize the use and distribution of energy within electric vehicle. It can monitor energy consumption, manage power distribution, and ensure efficient operation by controlling various components to reduce energy waste and improve overall performance.

In some embodiments, at a sixth station 1160 (e.g., a pack end-of-line test station), one or more stages of assembly as described with respect to FIG. 39 can be performed, such as at least a portion of the seventh stage 1080 (e.g., an end-of-line (“EOL”), encapsulant, and cover installation stage) of process 1000 as illustrated in FIG. 39. An end-of-line (“EOL”) test is a quality control process that can be conducted at the final stage of manufacturing to ensure that a product meets all specified requirements and functions correctly before it is shipped to customers. In the context of automotive manufacturing, EOL testing can involve checking various aspects of a vehicle's performance, safety features, and system functionalities to verify that it operates as intended. This process helps identify any defects or issues that need to be addressed before the product is delivered.

In some embodiments, at a seventh station 1170 (e.g., a pack potting and sealing station), one or more stages of assembly as described with respect to FIG. 39 can be performed. In some embodiments, at an eighth station 1180 (e.g., a module load station), the battery module can be loaded onto a vehicle.

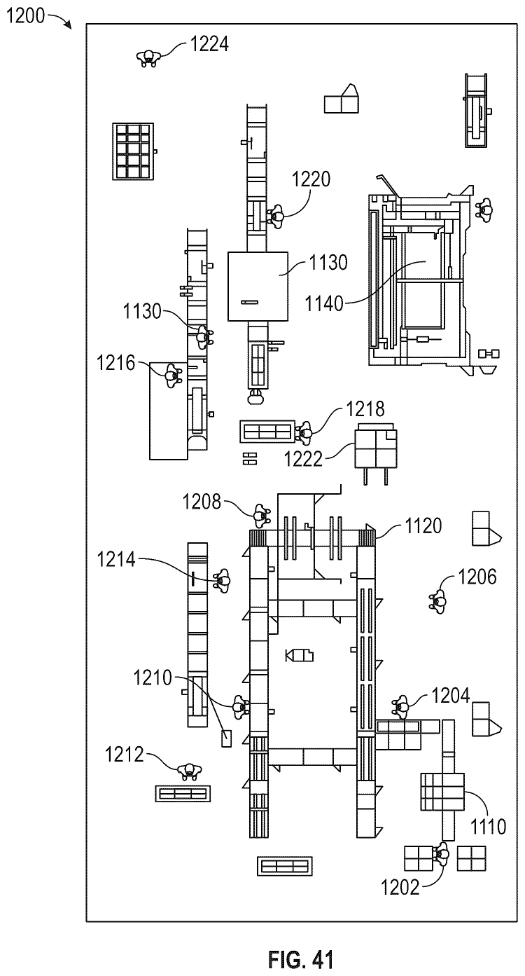

FIG. 41 illustrates a top view of a facility for assembling a battery module in accordance with one or more implementations of the present disclosure. The facility can provide stations for performing the operations described herein. For example, one or more stations can be provided to assemble a battery module as described herein. The facility illustrated in FIG. 41 can include at least some of the stations illustrated in FIG. 40.

In some embodiments, at the first station 1110 (e.g., a cell processing station), one or more stages of assembly as described with respect to FIG. 39 can be performed, such as one or more operations corresponding to block 1012 of process 1000 as illustrated in FIG. 39. For example, at location 1202, one or more battery cells can be loaded, tested, and/or conveyed onward.

In some embodiments, at the second station 1120 (e.g., a set of battery cells assembly station), one or more stages of assembly as described with respect to FIG. 39 can be performed, such as one or more operations corresponding to blocks 1014, 1016, 1018, 1020, 1022, 1024, 1032, 1034, 1036, 1052, and/or 1054 of process 1000 as illustrated in FIG. 39. For example, at location 1204, the battery cells and/or a cooling member or element can be loaded. By further example, at location 1206, the cooling element and/or the set of battery cells can be tested for electrical insulation (e.g., by HIPOT testing). By further example, at location 1208, the subassembly can be wicked, rotated, and/or cured as described herein. By further example, at location 1210, the set of battery cells can be loaded and conveyed onward. By further example, at location 1212, a base can be provided and the set of battery cells loaded thereon. By further example, at location 1214, the set of battery cells can be provided with one or more frames.

In some embodiments, at the third station 1130 (e.g., a module assembly station), one or more stages of assembly as described with respect to FIG. 39 can be performed, one or more operations corresponding to blocks 1062 and/or 1064 of process 1000 as illustrated in FIG. 39. For example, at location 1216, a current collector assembly can be provided to the one or more frames and pressed thereon.

In some embodiments, at the fourth station 1140 (e.g., a laser weld station), one or more stages of assembly as described with respect to FIG. 39 can be performed, such as one or more operations corresponding to blocks 1072, 1074, 1076, 1082, 1084, 1086, and/or 1088 of process 1000 as illustrated in FIG. 39. For example, at location 1216, a current collector assembly can be provided to the one or more frames and pressed thereon. By further example, at location 1218, one or more interconnect portions can be connected (e.g., welded) to the one or more battery cells. By further example, at location 1220, the welds can be inspected and/or tested, the thermistor can be installed, and/or the voltage sensing harness can be connected to the BVT module. By further example, at location 1222, one or more encapsulants can be dispensed, as described herein. By further example, at location 1224, the battery module can be offloaded for a packing procedure.

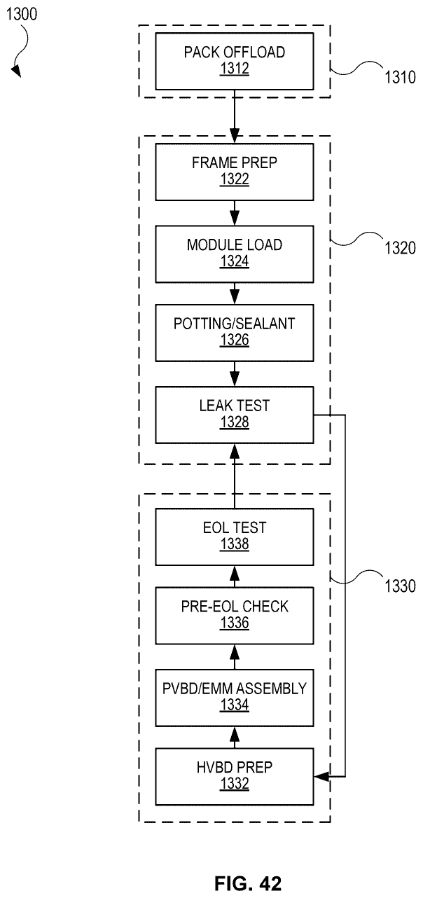

In accordance with one or more implementations of the present disclosure, a process is provided for packing a battery module. In accordance with one or more implementations of the present disclosure, a facility is provided in which a battery module is assembled. FIG. 42 illustrates a flow diagram showing an example of a process that may be performed for packing a battery module in accordance with one or more implementations of the present disclosure. For explanatory purposes, the process is primarily described herein with reference to components illustrated in FIG. 4-37. However, the process 1300 is not limited to the components illustrated in FIG. 4-37, and one or more blocks (or operations) of the process may be performed with one or more other components of other suitable apparatuses, devices, or systems. Further for explanatory purposes, some of the blocks of the process are described herein as occurring in serial, or linearly. However, multiple blocks of the process may occur in parallel. In addition, the blocks of the process need not be performed in the order shown and/or one or more blocks of the process need not be performed and/or can be replaced by other operations.

In a first stage 1310 (e.g., a battery module off-loading stage), and at block 1312, a set of battery cells can be loaded from a preceding stage and/or operation. For example, block 1312 can correspond to the operations at location 1224 of FIG. 41.

In a second stage 1320 (e.g., a pack preparation stage), a battery module can be prepared for packing. At block 1322, the battery module can be prepared, for example by providing one or more battery modules to a carriage. At block 1324, the battery module can be further prepared, for example by providing potting dams and/or testing for any leaks. At block 1326, a potting material can be dispensed, and a resulting profile thereof can be tested. The dispensation and testing can be performed in stages, such that testing can be performed as partial dispensation has occurred. At block 1328, the battery module can be tested for any leaks.

In a third stage 1330 (e.g., a pack configuration and offload stage), a battery module can be prepared for packing. At block 1332, the battery module can be flipped and/or otherwise oriented as needed. A high voltage distribution box and/or an energy management module can be prepared for installation, for example as described herein with respect to the fifth station 1150 of FIG. 40. At block 1334, the high voltage distribution box and/or the energy management module can be installed onto the battery module. At block 1336, the battery module can be prepared for end-of-line testing. At block 1338, end-of-line testing can be performed, for example as described herein with respect to the sixth station 1160 of FIG. 40. By further example, one or more tests can be performed, including verification of the functionality of the battery module. From block 1338, the battery module can return to the second stage 1320, for example at block 1328, in which the battery module can again be tested for any leaks. From block 1328, the battery module can be loaded onto a vehicle.

Aspects of the subject technology can help extend the life of a battery in a vehicle. This can help facilitate the functioning of and/or proliferation of batteries, which can positively impact the climate by reducing greenhouse gas emissions.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

The predicate words “configured to”, “operable to”, and “programmed to” do not imply any particular tangible or intangible modification of a subject, but, rather, are intended to be used interchangeably. In some embodiments, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S. C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A frame for a battery assembly, the frame comprising:
a structure for abutting a peripheral rim of each of multiple battery cells, the frame defining openings, the frame being configured to support a current collector assembly for extending across the frame and including interconnect portions for extending through the openings of the frame to the multiple battery cells;
one or more first engagers configured to form a first datum with the multiple battery cells;
one or more second engagers configured to form a second datum with the multiple battery cells; and
one or more third engagers configured to form a third datum with the current collector assembly.

2. The frame of claim 1, wherein:
the one or more first engagers are configured to surround one or more of the multiple battery cells; and
the one or more second engagers configured to extend between an adjacent pair of the multiple battery cells.

3. The frame of claim 1, wherein:
the first datum is a 4-way datum; and
the second datum is a 2-way datum.

4. The frame of claim 1, wherein the one or more third engagers are configured to extend into one or more CCA openings of the current collector assembly.

5. The frame of claim 1, the third datum is a 4-way datum.

6. The frame of claim 1, wherein the frame is further configured to support a cover extending across the current collector assembly, the frame further including one or more fourth engagers for forming a fourth datum with the cover.

7. The frame of claim 6, wherein the one or more fourth engagers are configured to extend into one or more cover openings of the cover.

8. The frame of claim 6, the fourth datum is a 4-way datum.

9. A battery subassembly comprising:
the frame of claim 1, wherein the frame is a first frame, wherein the battery cells are first battery cells, and wherein the structure is a first structure,
a second frame including:
a second structure for abutting a peripheral rim of each of multiple second battery cells;
one or more fifth engagers configured to form a fifth datum with the multiple second battery cells;
one or more sixth engagers configured to form a sixth datum with the multiple second battery cells; and
one or more seventh engagers configured to form a seventh datum with the current collector assembly.

10. The battery subassembly of claim 9, wherein:
the first frame and the second frame are further configured to support a cover extending across the current collector assembly;
the first frame further includes one or more fourth engagers for forming a fourth datum with the cover; and
the second frame further includes one or more eighth engagers for forming an eighth datum with the cover.

11. A method for assembling a battery assembly, the method comprising:
providing multiple battery cells;
aligning a frame to the multiple battery cells with one or more first engagers and one or more second engagers of the frame, the one or more first engagers forming a first datum with the multiple battery cells and the one or more second engagers forming a second datum with the multiple battery cells; and
aligning a current collector assembly with the frame with one or more third engagers of the frame, the one or more third engagers forming a third datum with the current collector assembly.

12. The method of claim 11, wherein:
the first datum is a 4-way datum; and
the second datum is a 2-way datum.

13. The method of claim 11, the third datum is a 4-way datum.

14. The method of claim 11, further comprising aligning a cover with the frame with one or more fourth engagers of the frame, the one or more fourth engagers forming a fourth datum with the cover.

15. The method of claim 14, the fourth datum is a 4-way datum.

16. The method of claim 11, further comprising:
aligning the frame to the multiple battery cells includes abutting, with a structure of the frame, a peripheral rim of each of the multiple battery cells; and
connecting interconnect portions of the current collector assembly with each of the multiple battery cells through respective openings of the frame.

17. A battery subassembly for a vehicle, the battery subassembly comprising:
a cover defining a cover opening extending through the cover and forming a shape with a first size;
a current collector assembly beneath the cover and including interconnect portions for electrically connecting to terminals of one or more battery cells, the current collector assembly defining a CCA opening extending through the current collector assembly and forming the shape with a second size smaller than the first size; and
a frame defining a frame opening extending through the frame and forming the shape with a third size smaller than the second size, wherein the cover opening, the CCA opening, and the frame opening are concentrically aligned.

18. The battery subassembly of claim 17, wherein the current collector assembly is connected to the one or more battery cells through additional frame openings in the frame.

19. The battery subassembly of claim 17, further comprising:
a base;
a potting dam extending along an end of the frame to the base; and
potting material between the cover and the base.

20. The battery subassembly of claim 17, wherein:
the cover further defines an additional cover opening extending through the cover and forming the shape with the first size;
the current collector assembly further defines an additional CCA opening extending through the current collector assembly and forming the shape with the second size; and
the frame further defines an additional frame opening extending through the frame and forming the shape with the third size, wherein the additional cover opening, the additional CCA opening, and the additional frame opening are concentrically aligned.
